(19) United States
(12) Patent Application Publication
(10) Pub. No.: US 2026/0196039 A1
(43) Pub. Date: Jul. 9, 2026

(54) SYSTEMS, METHODS, AND COMPUTER-READABLE MEDIA FOR ENRICHING IMAGES WITH SOCIAL DYNAMICS

(71) Applicant: Adeia Guides Inc., San Jose, CA (US)

(72) Inventors: Serhad Doken, Bryn Mawr, PA (US); Ning Xu, Irvine, CA (US); Aldis Sipolins, Somerville, MA (US); Tao Chen, Palo Alto, CA (US)

(21) Appl. No.: 19/009,813

(22) Filed: Jan. 3, 2025

(51) Int. Cl. G06V 20/30; G06T 11/60; G06V 40/10

(52) U.S. Cl. CPC G06V 20/30; G06T 11/60; G06V 40/10; G06V 2201/10

(57) ABSTRACT

Embodiments herein provide a system for displaying a visual identifier to indicate social dynamics between persons in a subject image. The system analyzes the subject image to detect persons in the subject image. The system identifies the detected persons by searching for an image of a plurality of images that depicts at least one of the detected persons. In some embodiments, the system detects and/or identifies persons based on their facial features. Social dynamics between the detected persons are determined using information corresponding to the plurality of images that depict the detected persons. In some embodiments, the social dynamics provide context for the subject image. In some embodiments, the social dynamics include relationships between the detected persons in the subject image. In some embodiments, the visual identifier is displayed simultaneously with the subject image, such as an overlay on the subject image or a modification to the subject image.

### BACKGROUND

This disclosure is related to techniques for enriching and updating metadata of an image.

### SUMMARY

Images of people may be posted to an online platform, such as various social media platforms. Such images may include two or more persons and may be captured at an occasion or event. The persons in the image may know each other well, or may have just met. However, the online platform may not identify the social dynamics or relationships between the persons. For example, the online platform may not identify how persons who appear in the image are related and/or the closeness of the relationships. Without this, a viewer of the image may not have desired context as to circumstances that form the setting for the image, or to how the viewer relates to the persons depicted in the image. Trying to determine the social dynamics between the persons in the image, and/or between the viewer and the persons in the image, may require an inordinate amount of time spent on online browsing or research, and may be beyond the capability of a human, especially if given only or even just starting from a single image. For example, identifying a person in an image may require much effort if a human has never seen the person before. If part of a person is obstructed in the image, such as part of a person's head, then identifying the obstructed person may not be possible.

Further, the image may be a picture or from a video taken at a moment in time. As time passes, the social dynamics between the persons in the image may change and relationships determined when the image was taken may become outdated. In some instances, the relationships change before the image is seen or displayed on the online platform. Thus, a mechanism for updating metadata of an image, e.g., based on identifying persons in the image, determining social dynamics between the persons in the image, determining the social dynamics between a person not depicted in the image and the persons depicted in the image, to ensure up-to-date social dynamics data is reflected in the metadata, is needed.

In one approach, a system identifies people depicted in a single image by “tagging” the image with names of persons in the image. In some instances, the system may automatically generate the tags when an image is posted. However, the tags may not be accurate, or the system may not have enough information to generate the tags. For example, the system may be limited to searching an online platform on which the image was posted. The online system may not have access to information about a person in the image. In one example, the online platform may not have a user account or user profile for the person. Although the system may be able to automatically identify persons in an image and generate tags for them, its metadata may not reflect social dynamics between the persons in the image, at least because each tag is limited to identifying a single person and thus does not provide context in relation to the social dynamics between persons.

Further, in such approach, the auto-generated tags may not provide an accurate or complete way to identify persons in an image. In one example, the tags may become outdated since they are generated upon posting and are not automatically updated. Thus, the tags in a single image may not provide enough information to determine the social dynamics between persons in the image.

In another approach, the system may receive tags for a single image as an input, such as via the online platform. For example, a user may tag a person in the image. In some instances, the system may receive tags to identify persons that cannot be automatically tagged by the system. In some instances, the system may not be able to tag a person if an input is not received. The system may also be unable to determine if a tag received correctly identifies a person that it tags. For example, a tag may identify a person that is not in the image. While this approach allows for identifying a person in an image, even after an image is posted, it does not provide an accurate or complete way to identify persons in an image. Further, the tags do not reflect social dynamics between the persons. Thus, a single image may not provide enough context, even with tags, to determine social dynamics or relationships between persons depicted in the image or between a person that is not depicted in the image (e.g., a viewer of the image) and persons depicted in the image.

Accordingly, there is a need to provide a way to dynamically and comprehensively update metadata for an image to reflect up-to-date social dynamics between persons in an image, so viewers may be able to understand the context of the image and/or personalize the context to the viewer.

To help address these problems, systems, methods, and computer-readable media are provided herein for updating metadata of an image in real time or on demand to reflect social dynamics between persons depicted in the image. Such a solution may leverage additional images or additional information to supplement information determined from a single image.

Such a solution may also leverage image recognition operations discussed herein to identify persons in an image, data analysis operations discussed herein to identify social dynamics between persons identified in the image, and image modification operations discussed herein to display visual identifiers or indicators that present the social dynamics simultaneously with the image.

The disclosed systems may provide, for simultaneous display with a subject image, a visual identifier that indicates a relationship between a first person and a second person depicted in the subject image. In some embodiments, the system causes overlay of the visual identifier on the subject image. In some embodiments, providing the visual identifier for display comprises modifying the subject image, such as modifying any of metadata for, a context of, and/or characteristics of, the subject image. In some embodiments, modifying the subject image comprises any one or a combination of augmenting, adding to, supplementing, removing from, or moving, manipulating, or transforming content or characteristics of, the subject image. The system analyzes the subject image to detect a first and second person depicted in the subject image. The system may search a plurality of stored images to identify at least one of the first person or second person in at least one of the stored images. In some embodiments, the system detects and/or identifies persons based on visual cues (e.g., their facial features, their appearance, and/or other visual cues depicted in the subject image). In one example, a relationship between the first and second persons is determined using information associated with the stored image(s) that corresponds to at least one of the first or second persons. The system associates an indication of the relationship with metadata of the subject image. In some embodiments, the determined relationship provides context for the subject image. In some embodiments, the relationship is part of social dynamics between the first and second persons in the subject image. In some embodiments, the social dynamics or relationship information is tailored or customized to who is depicted in the stored image(s). For example, a relationship between two high ranking or influential people in an image may be shown and/or saved to metadata while a relationship between other persons in the image may not. Thus, the system provides a technique for determining and presenting relationships between persons in a single image (e.g., the subject image).

Such aspects may enable, in real time, identifying a person in a media asset, such as any of an image, video, recorded video, video stream, real-time streaming video, or live stream and/or relationships between persons in the media asset, and dynamic updating of metadata in real time to reflect such information. In some embodiments, the metadata is of a subject image. In some embodiments, the metadata is added to a description for a live stream session. For example, a live stream description may present the relationships between persons appearing in the live stream. In some embodiments, metadata may be shared with other platforms, e.g., via an application programming interface (API), without transmitting the image itself, thereby conserving network and/or other computing resources in sharing, generating, and updating social dynamic information.

In some embodiments, the disclosed techniques may be used to enhance public safety. For example, a person may be granted or denied entry to a location (e.g., an office, a home, a dormitory, apartment of multiple persons, or other secured area) based on social dynamics or relationship information identified between the person or the multiple persons and a list of authorized persons. Illustratively, a person may be identified as being a relative of a resident, or a person may be identified as an authorized aid to or representative of an employee, and accordingly granted entry to a location. In another example, a person's presence at a location (e.g., detected by a security camera) may be provided with a notification indicating context to another user based on the identified relationship (e.g., “Dan is at your front door, you both went to Jeff's birthday party last week”). Thus, in some embodiments, the social dynamics or relationship information is tailored or customized to a particular entity or to a viewer of the media asset.

In some embodiments, the system checks to ensure the metadata is up-to-date. In some implementations, at predetermined intervals the system checks the information associated with the plurality of stored images for changes. In some implementations, a change to the information triggers the system to determine the social dynamics. In some implementations, the system again searches the stored images that comprise the detected persons to identify additional information. Rechecking the information over time may ensure the social dynamics are accurate. In some embodiments, the social dynamics are presented across a temporal domain. For example, the system may generate for display a presentation with visual identifiers that show changing social dynamics over time. In some embodiments, the stored images and/or the information associated with the stored images is stored in any one or a combination of a database, data repository, data store, or data lake. In some implementations, the stored images and/or the information are stored as structured or unstructured data.

In some embodiments of this disclosure, the system identifies detected persons by searching profile pictures of a social networking platform and comparing the detected persons in the subject image to detected persons in the profile images. In some implementations, the social networking platform comprises a platform specific to an organization that has profile pictures of its employees. In some examples, the organization includes any of a government, institute, university, or company. In some implementations, the social networking platform comprises a personal website having a profile for a person. The system determines the social dynamics using information from user profiles on the social networking platform that correspond to the profile pictures comprising the detected persons. For example, an “Education” or “School” field of user profiles may be used to determine social dynamics between detected persons, such as whether the detected persons may have studied together (e.g., attended the same school at the same or overlapping time, resulting in a personal relationship) or merely attended the same school at different times (e.g., resulting in a weak or non-existent relationship). In other examples, the user profile fields include any one or a combination of work, activities or interests or hobbies, affiliations, places visited or lived, or events attended, to name a few examples. Using a social networking platform may improve the accuracy of the determined social dynamics because the data source commonly includes personal and social information.

In some embodiments, the system detects a person in the subject image and is initially unable to identify the person. For example, the system may not find the unidentified detected person in a profile image of the social networking platform. In some embodiments, the system uses characteristics of the subject image to determine the social dynamics between the unidentified detected person and the other detected persons. For example, the system may analyze non-verbal cues by comparing any of positioning, facial expressions, body language, and/or clothing of the unidentified detected person to the other detected persons in the subject image to determine the social dynamics. The system may use objects depicted in the subject image, such as tables, plants, animals, logos, text, or any other objects to determine the social dynamics. In some embodiments, the system uses a user profile of an identified person to determine social dynamics between the unidentified detected person and the identified persons. For example, the unidentified detected person may appear in images posted in the user profile of the identified person and/or corresponding comments for the post of the images may provide insight into the social dynamics. In some embodiments, the system uses captions and/or comments posted in relation to the subject image to determine social dynamics. Using the subject image or user profiles of identified persons may provide additional avenues for determining the social dynamics.

In some embodiments, the system detects a first person and a second person in an image. The system searches a first plurality of stored images and identifies the first person but does not identify the second person. The system searches a second plurality of stored images to identify the second person. For example, the system identifies the second person in one of the second plurality of stored images and uses information corresponding to the one of the second plurality of stored images to determine a relationship between the second person and the first person. In some embodiments, the first plurality of stored images corresponds to information from a first social media platform and the second plurality of stored images corresponds to information from a second social media platform. Using the second plurality of stored images and corresponding information may improve the accuracy, completeness, or relevance of the social dynamics compared to using a single image or only the first plurality of images, such as by enabling identification of previously unidentified detected persons and by providing different data about identified persons.

In some embodiments, the disclosed system identifies a detected person that is partially obstructed in the subject image. In some embodiments, a face of the obstructed detected person is any of obstructed, not identifiable, or not captured in the subject image. The system identifies other images that are related to the subject image and searches the related images for the face of the obstructed detected person. In some embodiments, the other images are identified based at least in part on the presence of at least a portion of the detected persons. In some implementations, clothing appearance of the detected persons is used to identify the other images. In some embodiments, background features in the subject image are used to identify the other images. In some embodiments, the other images are posted in the same post as the subject image. In some embodiments, the other images include the plurality of stored images. Identifying obstructed detected persons may improve accuracy of the determined social dynamics by incorporating relevant information that is otherwise not considered.

In some embodiments, the disclosed system identifies social dynamics between persons in a media asset, such as, for example, a video, recorded video, video stream, real-time streaming video, live stream, or a sequence of successive images. The system updates the social dynamics at predetermined intervals and/or based on triggering events. In some embodiments, the system tracks persons in the media asset to determine if a person is no longer present in a frame of the media asset, if a new person is present, or if a previously present person returns. In some implementations, the system stores an identity and/or social dynamics for a person that is no longer present, which may reduce computational efforts if the previously present person returns. In some examples, the system continues to determine social dynamics between the person that is no longer present and persons that are present. In some implementations, the system ceases to determine social dynamics for a person that is no longer present, but may store previously determined social dynamics. In some implementations, the system determines social dynamics between a new person and the persons depicted in the media asset and updates the metadata. In some embodiments, the metadata is updated in real time. In some implementations, updates are propagated to previously created social dynamic metadata. For example, the previously created social dynamic metadata may be updated if an update is detected for a person in an image (e.g., a promotion offered by the person, a life event for the person, a change in a person's status or affiliation, etc.). Thus, the system provides a means for keeping the metadata up-to-date, and a means for determining and presenting social dynamics between persons in live content or “on the fly” as content is presented.

In some embodiments, the system infers relationships between depicted persons based on other determined relationships. In one example, an image depicts three persons (e.g., first person, second person, and third person). A relationship cannot be determined between the first and second persons but can be determined between the first and third persons and the second and third persons. The system may use information identified when determining the relationships between the first and third persons and the second and third persons to infer information and determine a relationship between the first and second persons.

In some embodiments, the system uses content of the subject image or the video to determine the social dynamics. For example, the video may include a caption about an event depicted in the video or a location of the video. In some embodiments, the video content is used to provide context for determining the social dynamics. In some embodiments, the content is dynamic content that changes as time, or the video, progresses, and the system updates the social dynamics based at least in part on the dynamic contents. Using content of the video may improve the determined social dynamics by incorporating relevant information that is otherwise not considered or apparent.

In some embodiments, the system uses web content or any other available content to determine the social dynamics. For example, the system may perform a web search using the information corresponding to an image of the stored images. In some examples, the system performs an image search of the web to identify a detected person. Additional information (e.g., websites, blog posts, publications, data stores, etc.) may be discovered and used to identify the detected person and/or determine social dynamics between the detected person and other persons depicted in the subject image.

In some embodiments, the system modifies the subject image to indicate the social dynamics between persons in a subject image. In some embodiments, any of distance between persons, clothing or appearance of persons, or other aspects or characteristics of the image are modified to depict the social dynamics. In some embodiments, the subject image is modified to present changing social dynamics. In some embodiments, the social dynamics are stored in metadata for the subject image. In some implementations, the metadata is metadata of the subject image and/or stored in a file for the subject image. Thus, the system provides a means for intuitively presenting social dynamics between persons in an image.

Using the techniques described herein, metadata for an image may be updated and enriched to reflect up-to-date social dynamics between persons in an image, and/or between a person not depicted in the image and the persons depicted in the image.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a schematic illustration of a system for enriching metadata to reflect up-to-date social dynamics between persons in an image, in accordance with embodiments of the disclosure;

FIG. 2 is a flowchart of a process for detecting and identifying persons in an image, in accordance with embodiments of the disclosure;

FIG. 3 is a flowchart of a process for determining social dynamics between persons in an image, in accordance with embodiments of the disclosure;

FIG. 4A is an illustrative representation of enhancing an image with different visual identifiers indicating social dynamics between persons in the image, in accordance with embodiments of the disclosure;

FIG. 4B is an illustrative representation of different visual identifiers indicating social dynamics between persons, in accordance with embodiments of the disclosure;

FIG. 5 is an illustrative representation of dynamically modifying an image with different visual identifiers indicating changing social dynamics between persons in the image over time, in accordance with embodiments of the disclosure;

FIGS. 6A-6E are illustrative representations of modifying an image with different visual identifiers indicating social dynamics between persons in the image, in accordance with embodiments of the disclosure;

FIG. 7 is a flowchart of a process for determining a relationship between an entity and a subject person in an image, in accordance with embodiments of the disclosure;

FIG. 8 is a sequence diagram defining communication between a system and a social profile repository, in accordance with embodiments of the disclosure;

FIG. 9 is a schematic illustration of determined social dynamics for frames of a video, in accordance with embodiments of the disclosure;

FIG. 10 depicts example devices and related hardware for determining and depicting up-to-date social dynamics between persons in an image, in accordance with embodiments of the disclosure; and

FIG. 11 depicts example systems, servers, and related hardware for enabling a metadata enrichment application to carry out the functions described herein, in accordance with some embodiments of this disclosure.

### DETAILED DESCRIPTION

As used herein, the phrase “social dynamics” refers to any information on how persons relate to, and/or have interacted with, one another. For example, social dynamics may include how persons know one another. Social dynamics may include interests, activities, or information common to, or shared between, persons. Social dynamics may include a type of relationship between persons (e.g., family, friends, co-workers, acquaintances, or friends of friends) or a strength of the relationship (e.g., strong, normal, weak). In some embodiments, social dynamics includes information on how interactions between persons may influence behavior of a person.

Extended reality (XR) may be understood as virtual reality (VR), augmented reality (AR) or mixed reality (MR) technologies, or any suitable combination thereof. VR systems may project images to generate a three-dimensional environment to fully immerse (e.g., giving a user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

In some embodiments, AR refers to any kind of display of a media asset, or digitally or optically produced content, which overlays a real-world environment. For example, AR may be provided using goggles or glasses worn by a user. That is, the goggles may allow the user to partially see the real world, while some digitally produced content is overlaid, by the goggles, over the real-world objects to create a mixed reality. In some embodiments, AR may also refer to content that overlays, or is simultaneously presented with, an image or series of images (e.g., a video). In some embodiments, AR may be provided on a display that is seen by a user and not worn by a user. In some embodiments, AR may also refer to a holographic projection of the media asset that overlays real-world objects or is projected in the real world.

As referred to herein, the phrase “display” refers to any device or devices to display the media asset. For example, a screen may be used, such as a TV, computer monitor, or phone screen, to name a few examples. Other devices may include a projector and projection surface, a screen of an XR device on which content is overlayed, or a holographic display, to name a few examples.

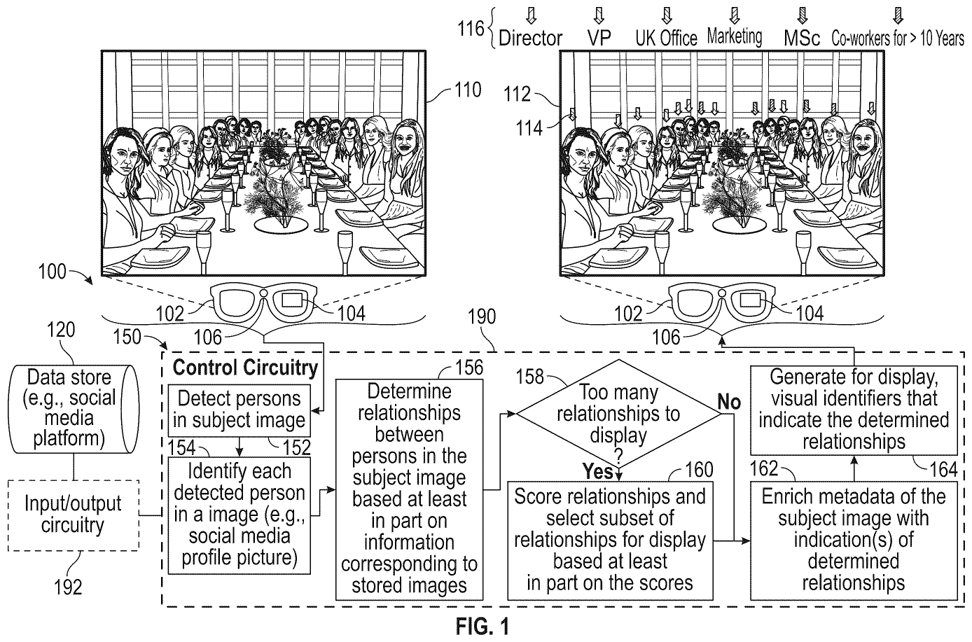

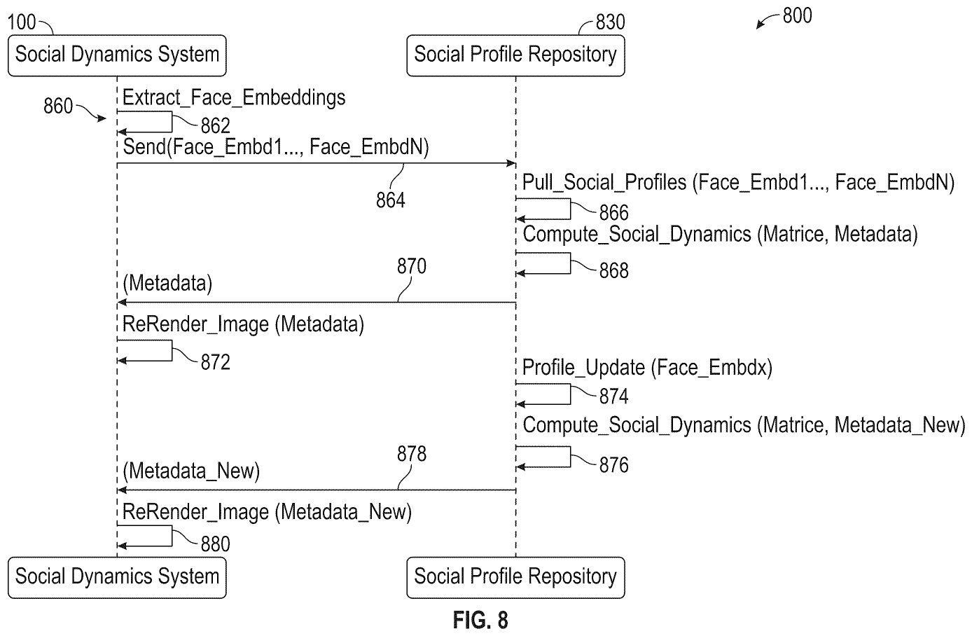

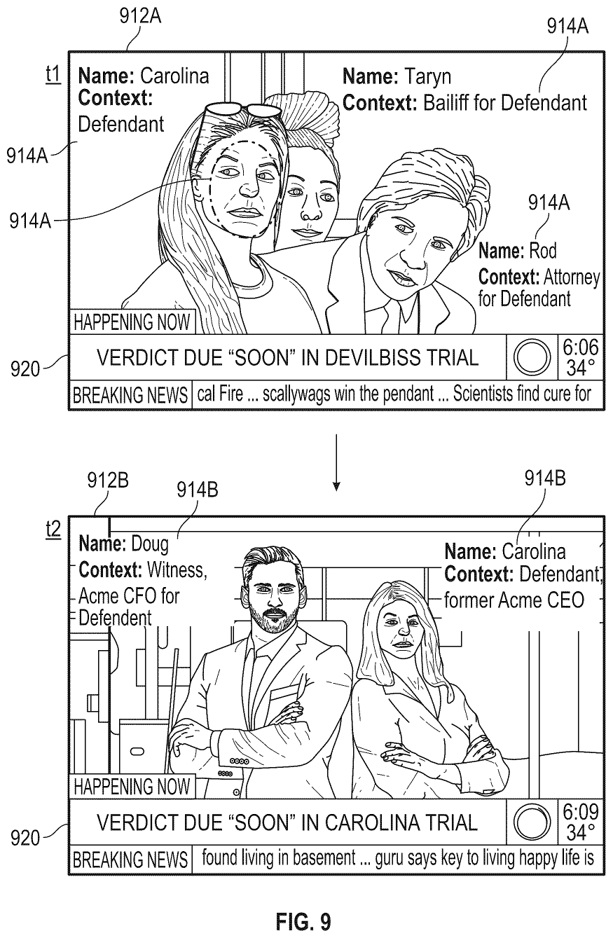

FIG. 1 is a schematic illustration of a system 100 for enriching metadata to reflect up-to-date social dynamics between persons in an image (e.g., subject image 110), in accordance with embodiments of the disclosure. In some embodiments, system 100 may be used to automatically determine relationships of persons depicted in the subject image 110 in real time. In some embodiments, the subject image 110 is a still image. In some embodiments, the subject image 110 is a frame of a video, such as discussed below in relation to FIGS. 8 and 9. As shown in FIG. 1, the subject image 110 depicts persons sitting at a table at a restaurant. The persons work for the same company. The system 100 may also be used to provide a means of presenting complex information in a user-friendly manner. In some embodiments, system 100 executes a process 150 to determine and depict the social dynamics between users or persons in an image.

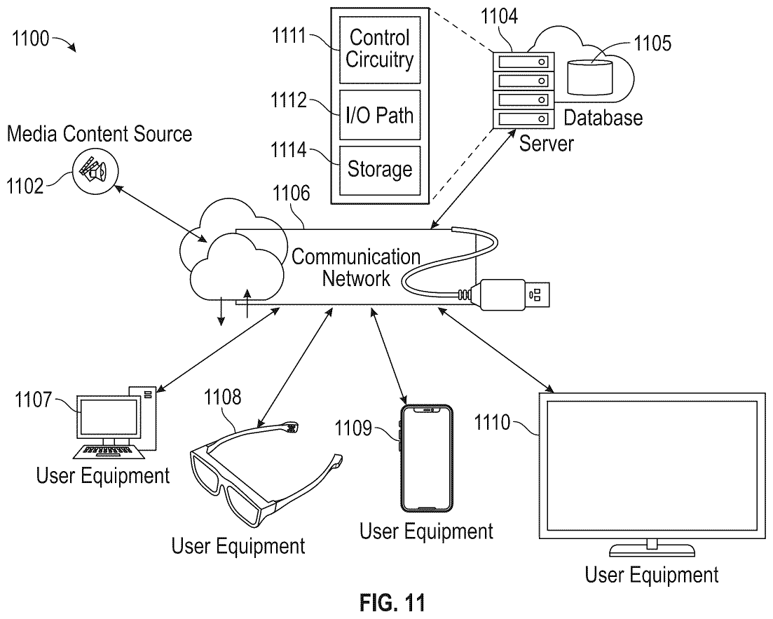

In some embodiments, system 100 may be configured to perform the functionalities (or any suitable portion of the functionalities) described herein. System 100 may be executed at least in part on computing device 102, and/or at one or more remote servers (e.g., server 1104 of FIG. 11) and/or at or distributed across any of one or more other suitable computing devices, in communication over any suitable type of network (e.g., the Internet). In some embodiments, the system may be or may comprise a stand-alone application, or may be incorporated (e.g., as a plugin) as part of any suitable application, e.g., content provider applications, live content provider applications, media asset provider applications, extended reality (XR) applications, e-commerce applications, video or image or electronic communication applications, social networking applications, image or video capturing and/or editing applications, content creation applications, or any other suitable application(s), or any combination thereof.

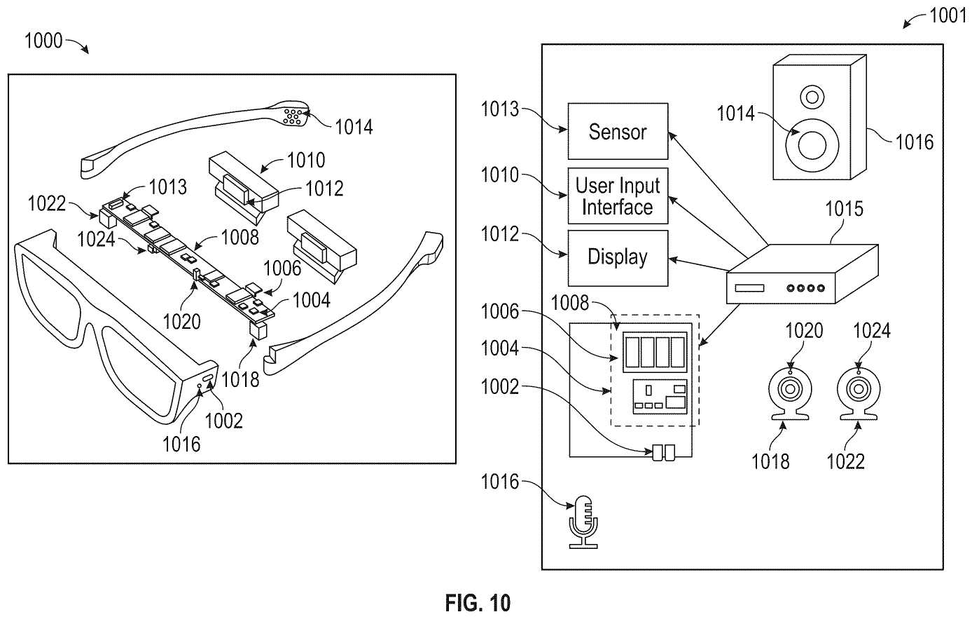

In some embodiments, the system 100 includes computing device 102, control circuitry 190, and input/output circuitry 192. In some embodiments, the computing device 102 includes a display 104 and sensors 106. In some embodiments, the display 104 (or, e.g., display 1012 of FIG. 10) displays an image. In some embodiments, the display 104 overlays information over a real-world environment or real-world objects to form a mixed reality.

Computing device 102 may comprise or correspond to, for example, a mobile device (such as a smartphone or tablet), a laptop computer, a personal computer, a desktop computer, a smart television, a smart watch or wearable device, a camera, smart glasses, a stereoscopic display, a wearable device, XR glasses, XR goggles, XR head-mounted display (HMD), near-eye display device, a set-top box, a streaming media device, or any other suitable computing device, or any combination thereof.

In some embodiments, the sensors 106 sense various conditions about the environment surrounding the computing device 102. For example, the sensors 106 may be used for any one of detecting nearby objects (e.g., furniture, furnishings, fixtures, a person, clothing, or fashion accessories), determining a proximity of (e.g., distance to) the nearby objects to the computing device 102 or to one another, or tracking motion of the nearby objects in relation to the computing device 102. In the embodiments depicted in FIG. 1, the environment surrounding the computing device 102 is a surrounding physical environment. In some embodiments, the environment includes a virtual environment or world. The sensors 106 may include any one or a combination of ultrasonic sensors, cameras, radar, lidar, or any other sensors capable of detecting the presence of objects, capturing a shape of the objects, detecting a color, or detecting the proximity of the computing device 102 to the objects or other features in the surrounding physical environment. In some embodiments, sensor data received from the one or more sensors 106 helps enable the computing device 102 to determine social dynamics between persons in the subject image 110. In some embodiments, the control circuitry 190 captures the subject image 110 using one of the sensors 106 (e.g., a camera) of the computing device 102.

In some embodiments, the control circuitry 190 includes processing circuitry (e.g., processing circuitry 1006 of FIG. 10) and/or storage (e.g., storage 1008, 1114 of FIGS. 10 and 11). In some implementations, the processing circuitry processes input to the control circuitry 190 (e.g., data and computer-executable instructions), stores data to the storage, and outputs results. In some implementations, the storage comprises non-transitory memory that stores inputs or data. In some embodiments, the I/O circuitry 192 receives input from and/or outputs to at least one of the sensors 106, the computing device 102, a data store 120 (or, e.g., social profile repository 830 of FIG. 8 or database 1105 of FIG. 11), or a user interface (e.g., user input interface 1010 of FIG. 10). In some embodiments, the I/O circuitry 192 includes an I/O path (e.g., I/O path 1002, 1112 of FIGS. 10 and 11). In some embodiments, the instructions are provided by the control circuitry 190 through the I/O circuitry 192. In some embodiments, the control circuitry 190 and I/O circuitry 192 reside in or on the computing device 102. In some embodiments, the control circuitry 190 executes the process 150 to generate an enriched image 112 (or, e.g., annotated image) based on the subject image 110. In some embodiments, the control circuitry 190 initializes or executes the system 100 to execute the process 150.

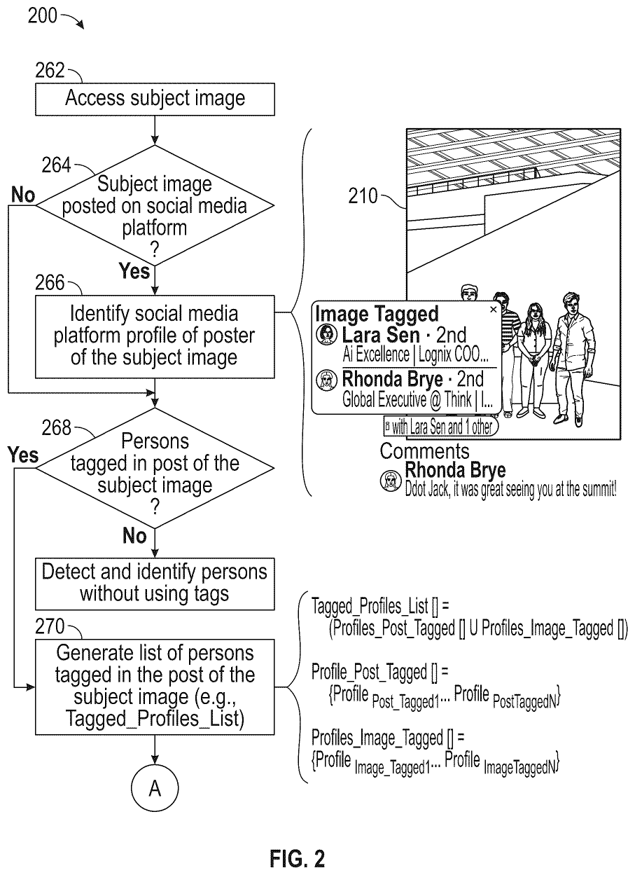

In some embodiments, the system 100 includes one or more applications to determine and present social dynamics between persons in the subject image 110. For example, the control circuitry 190 of the system 100, by running a metadata enrichment application, processes computer-executable instructions to analyze the subject image 110 to detect persons and determine the relationships between them. In some examples, the applications are stored in a non-transitory memory, which may be local storage on the computing device 102 or off-device storage (e.g., of a different device and/or of a server). In some implementations, instructions for the applications are stored in the non-transitory memory, and when executed, perform the operations of the process 150 (or, e.g., processes 200, 300, 700, or 860, described below in relation to FIGS. 2, 3, 7, or 8). In some implementations, the system 100 includes a computer (e.g., user equipment device 1107 of FIG. 11) having the non-transitory memory with non-transitory instructions, that, when executed, cause the execution of the applications. In one example, the control circuitry 190 and I/O circuitry 192 are part of the computer and/or server having the non-transitory memory.

In some embodiments, the control circuitry 190 executes the metadata enrichment application to communicate with at least one of the sensors 106, the computing device 102, the data store 120, or a user interface through the I/O circuitry 192. In some embodiments, system 100 interfaces with the other applications, such as via the control circuitry 190, to carry out its functions. In some embodiments, the control circuitry 190 executes a metadata enrichment application to communicate with a user device. The control circuitry 190 is capable of sending and receiving communications over a communication network (e.g., communication network 1106 of FIG. 11) to communicate with any of the sensors 106, the computing device 102, the data store 120, or other devices, to name a few examples. In some embodiments, the data store 120 includes any of a database, data lake, or other type of data repository. In some embodiments, the data store 120 is used to store structured and/or unstructured data.

In some embodiments, the control circuitry 190 executes an image analysis application to perform any of detecting persons depicted in the subject image 110, identifying the persons depicted in the subject image 110, or identifying characteristics of what is depicted in the subject image 110. In some implementations, the characteristics include any of objects (e.g., tables, plants, animals, logos, symbols, names, etc.), clothing, fashion accessories, or non-verbal cues, to name a few examples. In some examples, the non-verbal cues include any of body language (e.g., persons standing close to one other, leaning away from one another, etc.), facial expressions indicating emotions (e.g., smile, laugh, frown, grimace, etc.), body contact (e.g., handshake, hug, high-five, etc.), poses, or gestures. The control circuitry 190 executes a relational determination application to do any of parse through the data store 120, train and/or execute models to determine social dynamics, or analyze characteristics of the subject image 110. In some implementations, the relational determination application interfaces with the image analysis application to analyze the characteristics. In some implementations, the relational determination application uses the characteristics identified by the image analysis application. The control circuitry 190 executes a relational ranking application to do any of rank or grade social dynamics between persons in the subject image 110 or determine which social dynamics to present. In some implementations, the relational ranking application interfaces with the relational determination application to rank or grade the social dynamics. In some implementations, the relational ranking application uses the social dynamics determined by the relational determination application. The control circuitry 190 executes an image-enhancing application to perform any one or a combination of augment the subject image 110, modify the subject image 110, or generate, modify, or enhance metadata associated with the subject image 110, to name a few examples. In some implementations, executing the image-enhancing application generates the enriched image 112.

In some embodiments, the control circuitry 190 communicates with a server (e.g., server 1104 of FIG. 11) and at least part of at least one of the applications runs on a server, such as discussed in relation to FIG. 11. In some implementations, the instructions for the applications are stored on the server.

In some embodiments, the process 150 starts at operation 152 with the control circuitry 190 (or, e.g., control circuitry 1004, 1111 of FIGS. 10 and 11) detecting persons in the subject image 110. For example, image-processing techniques may be used to extract meaningful information from the subject image 110. In some embodiments, the control circuitry 190 detects persons by analyzing the metadata associated with the image. In some implementations, the metadata is metadata for the image and stored as part of the image file. In some implementations, the metadata is stored separately from the image file (e.g., in a separate file or in a data store). In some embodiments, the control circuitry 190 analyzes the subject image 110 (e.g., pixels or groupings of pixels of the subject image 110) to detect persons. In some implementations, the control circuitry 190 inputs the subject image 110 into a trained machine learning model, which outputs an indication that one or more persons have been detected in the subject image 110 (and/or an indication of an identity of one or more persons depicted in subject image 110), such as discussed below in relation to FIG. 2. In some examples, the trained machine learning model is a deep learning model, such as a convolutional neural network (CNN).

In some embodiments, a tag identifying a person is associated with the subject image 110, such as discussed below in relation to FIG. 2. In some implementations, the tags are used to detect persons in the subject image 110. In some implementations, the subject image 110 is tagged such that the tags appear on or in the subject image 110. In some embodiments, the tags are displayed with the subject image 110, and in some examples, are part of posts that are associated with the subject image 110. In some implementations, the tags are part of the metadata associated with the image. In some embodiments, the image analysis application executes on the control circuitry 190 to provide instructions to the control circuitry 190 to perform the operation 152.

The process 150 continues to operation 154 with the control circuitry 190 identifying each detected person in one or more images of a plurality of stored images (e.g., in the data store 120). For example, system 100 may perform facial recognition on subject image 110 to extract features of a detected person's face for comparison with facial features of persons in one or more of the plurality of images stored at 120. In some embodiments, the control circuitry 190 mines the data store 120 to identify detected persons. In some embodiments, the control circuitry 190 accesses the data store 120 through the I/O circuitry 192. In some embodiments, images comprising the detected persons are referred to as the identified stored images.

In some embodiments, the data store 120 is for a social media platform. In some implementations, the control circuitry 190 accesses the data store using an application programming interface (API). In some implementations, the one or more images of the plurality of images correspond to one or more images (e.g., a profile picture or other image) associated with a user profile of the social media platform. In some implementations, control circuitry 190 identifies the user profile by comparing a detected person in the subject image 110 to persons in images associated with user profiles to find user profiles comprising photos depicting the detected person. In some examples, the detected person is compared to profile pictures of the social media platform. In some embodiments, a profile picture comprises an image that is used to represent a user or user profile or account in interactions across a platform (e.g., social media platform, website, or webpage). For example, a profile image may be displayed next to an account name or profile name on any of posts, comments and mentions by or associated with the user profile. Searching profile pictures, and in particular searching only profile pictures (e.g., not images posted in social media posts), may enable reducing the computational resources required to identify matching user profiles, reduce the amount of time required to identify matching user profiles, and/or increase the accuracy and/or relevance of identified user profiles. In some implementations, operation 152 detects faces in the subject image 110, and the detected faces are used to identify the images associated with the user profiles. In some implementations, the control circuitry 190 inputs the images associated with the user profiles and one of the detected persons (e.g., from operation 152) into a trained machine learning model, which outputs data indicating one or more user profiles that have images depicting the detected person, such as discussed below in relation to FIG. 2. In some embodiments, the data store 120 comprises a database, and the control circuitry 190 identifies a database entry of the database for each detected person. In some implementations, each database entry comprises an image and information corresponding to the image.

In some embodiments, tags associated with the subject image 110 are used to identify information about persons in the subject image 110, such as discussed below in relation to FIG. 2. In some implementations, the tag links to the relevant information. In some implementations, the tags link to user profiles of a social media platform. In some embodiments, the tags are used with detected persons in the subject image 110 to identify information about persons in the subject image 110. In some embodiments, the image analysis application executes on the control circuitry 190 to provide instructions to the control circuitry 190 to perform the operation 154.

In some embodiments, operation 154 includes identifying images in more than one data store 120. In some examples, some of the detected persons from operation 152 are not found in the images of the plurality of images. In other examples, a number of tags from operation 152 is different from a number of detected persons in the subject image 110, or the tags do not link to information in the data store 120. The control circuitry 190 identifies information in a different data store for the detected persons that are not found the data store 120. In some implementations, the information of the different database corresponds to a user profile of a different social media platform. In some implementations, the control circuitry 190 identifies an image of a second plurality of images that corresponds to the detected persons that are not found in the data store 120.

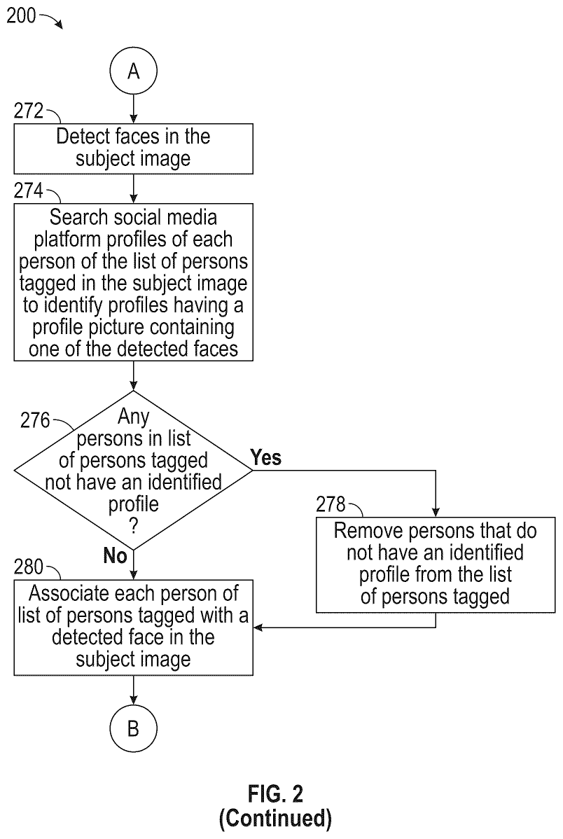

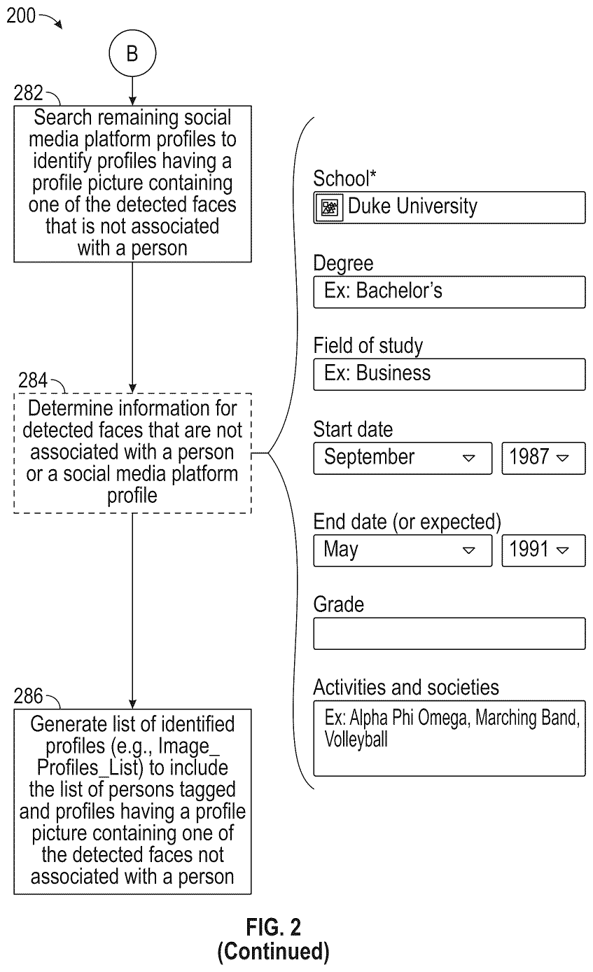

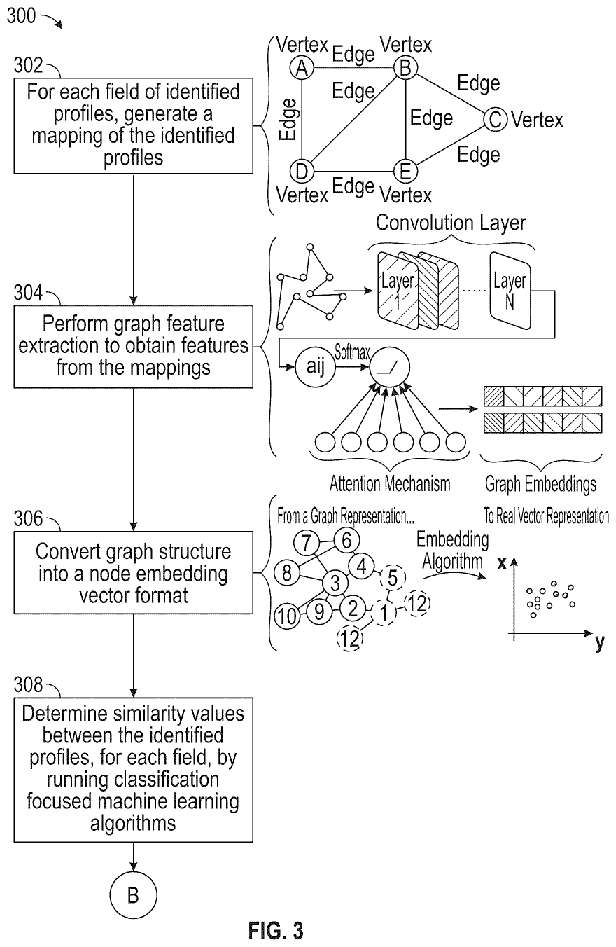

In some embodiments, the control circuitry 190 creates or modifies a data structure comprising entries corresponding to user profiles for the detected persons, such as discussed below in relation to FIGS. 2 and 3. In some implementations, the data structure comprises information corresponding to the plurality of images. In some examples, the data structure comprises entries corresponding to more than one social media platform. In some implementations, a data structure is created for each type of relationship information. In some examples, the information corresponding to each image comprises a plurality of fields, and a database structure is created for each field of the information.

The process 150 continues to operation 156 with the control circuitry 190 determining relationships between persons in the subject image 110 based at least in part on the information corresponding to the identified stored images (such as identified at operation 154). In the embodiment depicted in FIG. 1, the relationships include information that is common between two or more of the persons depicted. In some embodiments, the control circuitry 190 determines the relationships based at least in part on the identified user profiles of the social media platform. In some implementations, the information for the identified stored image comprises a user profile. In some implementations, information contained within fields or sections of the identified user profiles (e.g., fields discussed in relation to FIG. 2) are compared to determine the relationships. In some examples, any one or a combination of work, education, or places lived fields, and/or any other suitable field, of the identified user profiles is used to determine the relationships. In some implementations, a relationship exists if a field common to more than one user profile comprises information that is similar or the same for at least two of the user profiles. In some embodiments, information about an identified person is compared against information about other identified persons.

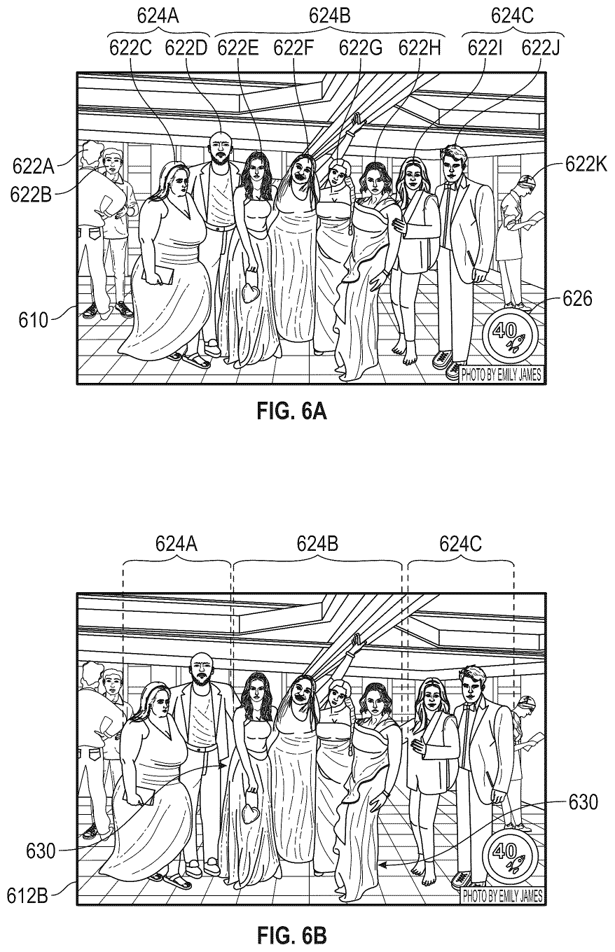

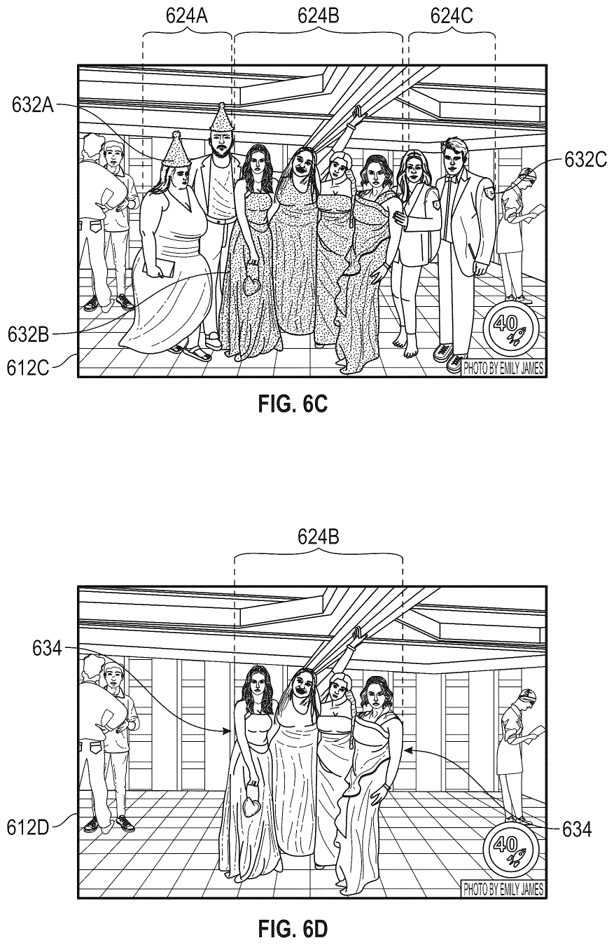

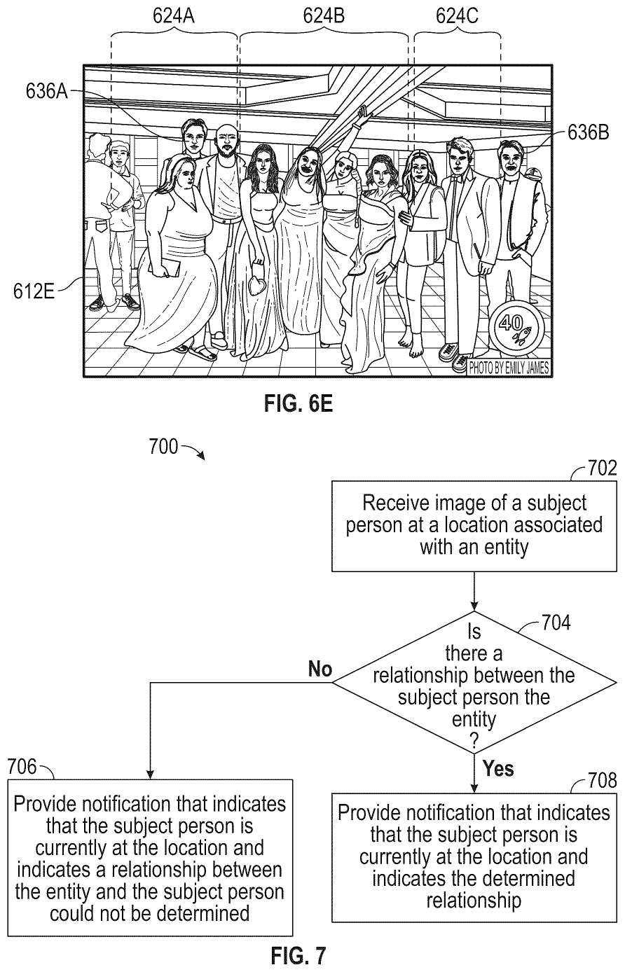

In some embodiments, the control circuitry 190 determines the relationships by mining a data structure comprising entries corresponding to user profiles for the detected person. In some implementations, the control circuitry 190 created or modified the data structure (e.g., in operation 154). In some embodiments, the control circuitry 190 determines the relationships using characteristics of what is depicted in the subject image 110, such as discussed below in relation to FIGS. 6A-6E and 9. In some embodiments, the control circuitry 190 determines the relationships based on the type of data store 120. For example, the relationships may tend to be professional relationships if the data store 120 is a professional network social media platform. The relationships may tend to be personal relationships if the data store 120 is a personal social media platform. The relationships may tend to be relationships if the data store 120 is a personal social media platform.

In some embodiments, the control circuitry 190 determines the relationships based on posts that are associated with the subject image 110. In some implementations, the relationships are determined using text of a post (e.g., a caption or a hashtag) that comprises the subject image 110, such as an original post comprising the subject image 110. In some implementations, the relationships are determined using posts associated with the subject image 110, such as replies to the original post comprising the subject image 110 (e.g., replies in that form a single conversation thread) or reposts of the subject image 110. In some embodiments, the captions or posts are considered characteristics of the subject image 110. In some embodiments, the control circuitry 190 determines the relationships based on user input (e.g., user request or user-provided context) or information about a user (e.g., from a user profile or user input). Thus, the system 100 may personalize and customize the relationships or context in which the relationships are determined.

In some embodiments, the determined relationships are stored in metadata associated with the subject image 110. In some implementations, the metadata comprises a data structure that is different from the data store 120. In some implementations, the metadata is metadata of an image file for the subject image 110. In some implementations, the control circuitry 190 generates the metadata or creates new metadata. In some embodiments, the metadata comprises an indication of one or more portions of the subject image 110 that comprise at least one of the depictions of the first or second person. In some embodiments, the metadata comprises an identity of at least one of the first person or the second person. In some embodiments, the metadata comprises information corresponding to images (e.g., profile pictures) of the social media platform. In some embodiments, the determined relationships are stored in the data store 120. In some embodiments, the relational determination application executes on the control circuitry 190 to provide instructions to the control circuitry 190 to perform the operation 156.

The process 150 continues to operation 158 with the control circuitry 190 determining whether there are too many relationships to display effectively. For example, displaying too many relationships may provide too much information for a viewer to process or, when displaying the information as an overlay, may crowd the subject image 110. In some embodiments, only one relationship is displayed per person. In the embodiment depicted in FIG. 1, only one visual identifier 114, which indicates a type of relationship, is shown for each person depicted in the enriched image 112. In some embodiments, there are too many relationships to display if the number of relationships exceeds a relationship threshold. In some implementations, the relationship threshold is applied to each detected person. In some implementations, the relationship threshold is applied to the enriched image 112. In some examples, the relationship threshold is at least five, or at least seven, or at least 10, or at least 15, to name a few examples. In some embodiments, the relational ranking application executes on the control circuitry 190 to provide instructions to the control circuitry 190 to perform the operation 158.

If the determination at operation 158 is that there not too many relationships to display, then the process 150 continues to operation 162 (discussed below). If the determination at operation 158 is that there are too many relationships to display, then the process 150 continues to operation 160 with the control circuitry 190 scoring the relationships and selecting a subset of the scored relationships for display based at least in part on the relationship scores. In some implementations, certain types of relationships are scored higher than other types. In some embodiments, the control circuitry 190 scores relationships based on user input (e.g., user request or user-provided context) or information about a user (e.g., from a user profile or user input). In some implementations, types of relationships associated with a user, such as a viewer of the subject image 110, are scored higher than other types. Thus, the system 100 may personalize and customize the relationships selected for display and enable custom augmentation of the subject image 110.

In some embodiments, each relationship type between each detected person is scored, such as discussed below in relation to FIG. 3. In some embodiments, any one or a combination of the relationship scores and the relationship types are stored in metadata associated with the subject image 110. In some embodiments, the relational ranking application executes on the control circuitry 190 to provide instructions to the control circuitry 190 to perform the operation 160.

The process 150 continues to operation 162 with the control circuitry 190 enriching metadata of the subject image 110 with an indication(s) of the determined relationships (determined at operation 156). In some embodiments, the control circuitry 190 associates the indications of the determined relationships with the metadata of the subject image. In some embodiments, the control circuitry 190 updates the metadata of the subject image 110 to include the indications of the determined relationships. In some embodiments, the image-enhancing application executes on the control circuitry 190 to provide instructions to the control circuitry 190 to perform the operation 162.

The process 150 continues to operation 164 with the control circuitry 190 generating for display visual identifiers 114 that indicate the determined relationships (determined at operation 156). In some embodiments, the control circuitry 190 depicts the visual identifiers 114 with the subject image 110 or depicts the enriched image 112. In some embodiments, the control circuitry 190 generates the enriched image 112 for display. The enriched image 112 includes visual identifiers 114 indicating the relationships between the persons depicted in the subject image 110. A relationship key 116 links the visual identifiers 114 to the relationship. For example, an arrow indicates one or more persons that are related because they have the position title of Director at the company. Another arrow indicates one or more persons that are related because they have a position title of Vice President at the company. Another arrow indicates persons that are related because they work for the United Kingdom (UK) office of the company. Another arrow indicates one or more persons that are related because they work in the marketing department of the company. Another arrow indicates persons that are related because they have a Master of Science and work at the company. Another arrow indicates persons that are related because they have been co-workers at the company for more than 10 years. In some embodiments, the subject image 110 comprises a person that does not work at the company. In some implementations, the control circuitry 190 determines a relationship between the person that does not work at the company and other persons, and does generate corresponding visual indicator 114. The determined relationship may not relate to working at the company, and in some examples, may be a personal relationship (e.g., friends, roommates, former co-workers, spouse or significant other, etc.). In some implementations, the control circuitry 190 is not able to determine a relationship between the person that does not work at the company and the other persons, and does not generate a visual indicator 114 for the person that does not work at the company.

In some embodiments, the visual identifiers 114 comprise the relationship key 116. In some embodiments, the control circuitry 190 generates the enriched image 112 based at least in part on the metadata. In some implementations, the metadata comprises an indication of which type of visual identifier 114 to display (e.g., visual identifiers 114 with or without the relationship key 116).

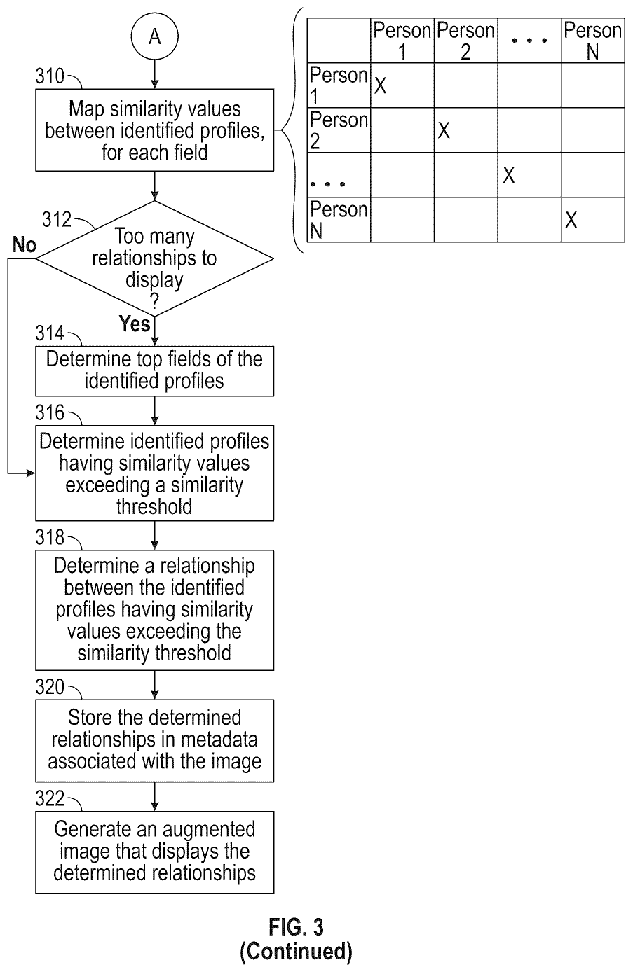

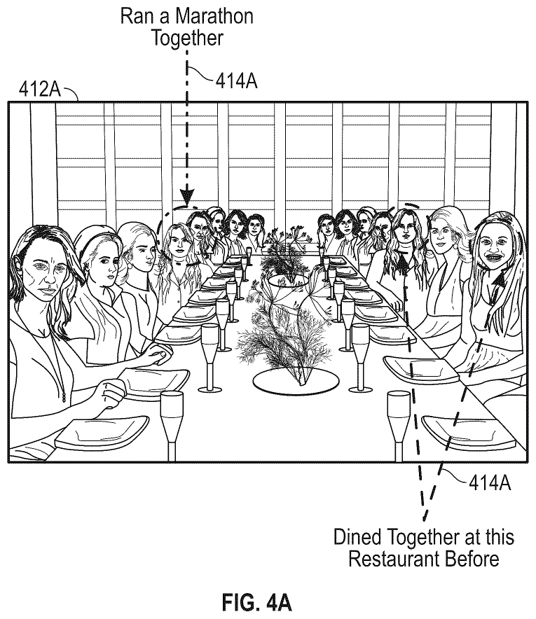

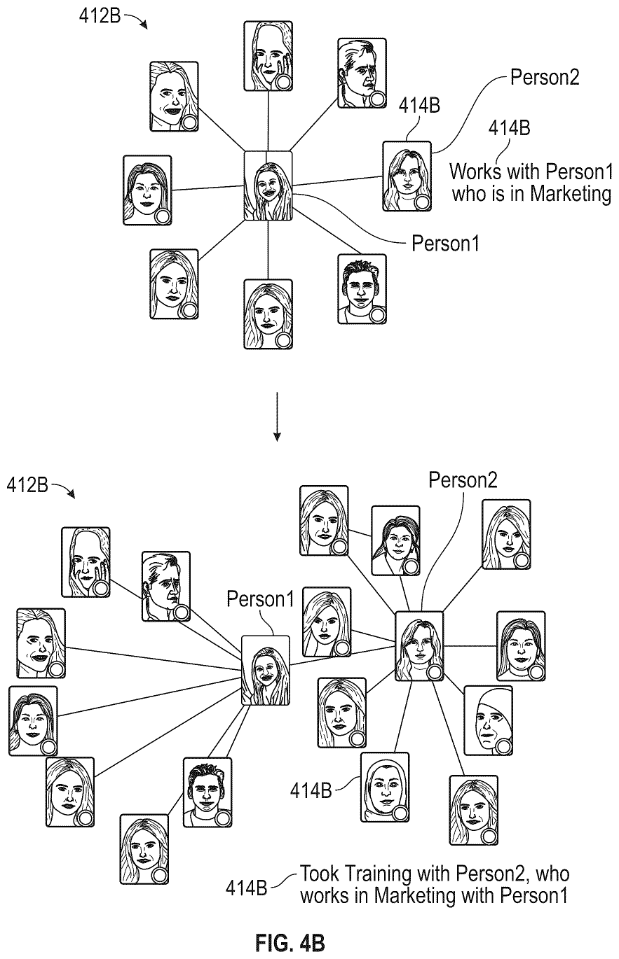

In some embodiments, the visual identifiers 114 enhance the subject image 110 by annotating with text explaining the relationship, such as discussed below in relation to FIGS. 4A-5 and 9. In some embodiments, the visual identifiers 114 are provided with the subject image 110, but are not overlaid on the subject image 110, such as discussed below in relation to FIG. 4A. In some embodiments, the visual identifiers 114 are generated using metadata associated with the subject image 110. In some implementations, the determined relationships are shared with other systems or circuitry, e.g., by transmitting the metadata and not the subject image 110. In some examples, the control circuitry 190 sends the metadata without image data to other systems or circuitry. In some examples, sharing of the metadata is enabled (e.g., via a system setting or user request/input). In some implementations, metadata comprising the determined relationships is received by the control circuitry 190, such as discussed below in relation to FIG. 8. In some implementations, control circuity 190 generates the visual identifiers for display based at least in part on the metadata comprising the relationships. In some implementations, the control circuitry 190 generates the visual identifiers 114 for overlay on the real-world environment using the display 104 to form the enriched image 112. In some embodiments, the control circuitry 190 generates the relationship key 116 for display on the display 104 of the computing device 102.

In some embodiments, the control circuitry 190 outputs an image (e.g., the enriched image 112) and generates the relationship key 116 for display on the outputted image. In some embodiments, the enriched image 112 is generated for display on a display of a secondary device (e.g., display 1012 of FIG. 10) different from the computing device 102. In some embodiments, the visual identifiers 114 and/or the relationship key 116 is generated for display with the subject image 110, but not as an overlay to the subject image 110. In some embodiments, the image-enhancing application executes on the control circuitry 190 to provide instructions to the control circuitry 190 to perform the operation 164.

FIG. 2 is a flowchart of a process for detecting and identifying persons in a subject image 210 (or, e.g., subject image 110 of FIG. 1 or subject image 610 of FIG. 6A), in accordance with embodiments of the disclosure. In some embodiments, the process 200 is performed to analyze the subject image 210. In some embodiments, the process 200, or a portion thereof, is used as part of or instead of operations 152, 154 of FIG. 1.

The process 200 begins at operation 262 with control circuitry (e.g., control circuitry 190 of FIG. 1, or control circuitry 1004, 1111 of FIGS. 10 and 11) accessing the subject image 210, such as described above with respect to FIG. 1. In some embodiments, the subject image 210 is accessed via a social media platform. In some implementations, the subject image 210 is posted on a social media platform. In some embodiments, the control circuitry accesses metadata of the subject image 210.

The process 200 continues to operation 264 with the control circuitry determining whether the subject image 210 is posted on a social media platform, such as described above with respect to FIG. 1. In some embodiments, the determination is based at least in part on image-processing techniques to analyze the subject image 210. In some embodiments, the determination is based at least in part on image-processing techniques to analyze a webpage or platform on which the subject image 210 is posted or embedded. In some embodiments, metadata of the subject image 210 indicates whether the subject image 210 is posted to a social media platform. In some embodiments, the control circuitry communicates with a webpage or platform (e.g., via an API), such as through I/O circuitry (e.g., I/O circuitry 192 of FIG. 1), to access the subject image 210. In some implementations, the webpage or platform indicates whether it is a social media platform. In some embodiments, a platform includes a webpage or website. In some embodiments, the operation 264 is performed before, as part of, or after operation 152 discussed in relation to FIG. 1. If the determination at operation 264 is no, then the process 200 continues to operation 268.

If the determination at operation 264 is yes, then the process 200 continues to operation 266 with the control circuitry identifying a social media platform profile of poster of the subject image 210. In some embodiments, the operation 266 is performed before, as part of, or after operation 152 of FIG. 1.

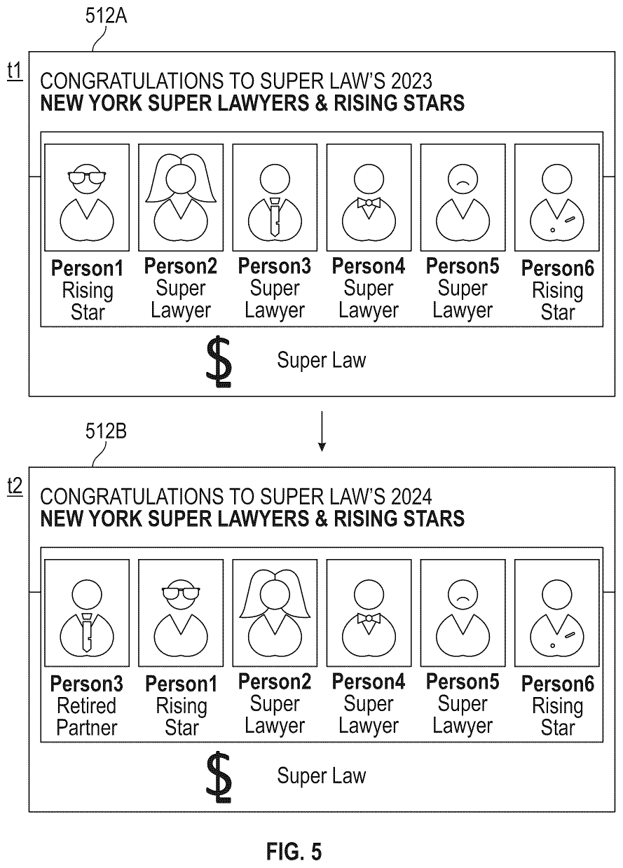

The process 200 continues to operation 268 with the control circuitry determining whether persons are tagged in a post of the subject image 210. In some embodiments, the subject image 210 is tagged. In some embodiments, the post that comprises the subject image 210 is tagged. In some implementations, the post is an original post that includes the subject image 210 and text (e.g., a caption) with at least one tag. In some implementations, the post is a post associated with the subject image 210 (e.g., posted in reply to the original post). The process 200 further checks if the post of the subject image 210 is tagged or comprises tags. In some embodiments, the operation 268 is performed before, as part of, or after operation 152 discussed in relation to FIG. 1. If the determination at operation 268 is no, then the process 200 continues to detect and identify persons without using tags, such as discussed in relation to FIG. 1, and below in relation to FIGS. 5-7 and 9.

If the determination at operation 268 is yes, then the process 200 continues to operation 270 with the control circuitry generating a list of persons tagged in the post of the subject image 210 (e.g., Tagged_Profiles_List [] of FIG. 2). In some embodiments, the list comprises at least one of image tags (e.g., Profiles_Image_Tagged [] of FIG. 2) and post tags (e.g., Profiles_Post_Tagged [] of FIG. 2). In some implementations, the image tags comprise a list of persons tagged in the subject image 210. In some implementations, the post tags comprise a list of persons tagged in the post of the subject image 210, such as discussed in relation to FIG. 1. In some embodiments, the list of persons is linked or associated with social media platform profiles for the persons tagged in the post of the subject image 210. In some embodiments, the metadata of the subject image 210 comprises any one or a combination of the list of persons, list of image tags, or list of post tags. In some embodiments, the control circuitry modifies the metadata of the subject image 210 to include the lists.

The process 200 continues to operation 272 with the control circuitry detecting faces in the posted subject image 210, such as described above with respect to FIG. 1. In some embodiments, faces that are obstructed or have visibility issues are filtered out of the detected faces, or are not able to be detected. In some embodiments, the control circuitry modifies the metadata of the subject image 210 to include an indication of one or more portions of the subject image 210 that comprise at least one depiction of a face.

The process 200 continues to operation 274 with the control circuitry searching social media platform profiles of each person, of the list of persons, tagged in the posted subject image 210 to identify profiles having a profile picture comprising one of the detected faces. In some embodiments, the detected faces are segmented, and the control circuitry searches the social media platform profiles using the segmented faces. In some embodiments, the control circuitry performs a reverse face search based on face detection. In some implementations, the results of the face search are mapped into a face-embedding parameter set. In some examples, the control circuitry searches social media platform profiles only within a face-embedding parameter set domain. For example, the face-embedding parameter set may comprise a detected face for a tagged person and the control circuitry searches for the for the detected face in profiles of the social media platform corresponding to the tagged person.

The process 200 continues to operation 276 with the control circuitry determining whether any persons in list of persons tagged do not have an identified profile. If the determination at operation 276 is no, then the process 200 continues to operation 280.

If the determination at operation 276 is yes, then the process 200 continues to operation 278 with the control circuitry removing persons that do not have an identified profile from the list of persons tagged.

The process 200 continues to operation 280 with the control circuitry associating each person, of the list of persons, tagged with a detected face in the posted subject image 210. In some embodiments, no social media platform profile is found for at least one face that was detected in the subject image 210. For example, at least one detected face in the posted subject image 210 may not be associated with a person on the list of persons tagged. In some implementations, the control circuitry generates a list of detected faces or people that do not have a profile (e.g., FaceEmbeddings_NoProfiles []={FaceEmbedding1 . . . FaceEmbeddingN}).

The process 200 continues to operation 282 with the control circuitry searching remaining social media platform profiles to identify profiles having a profile picture comprising one of the detected faces that is not associated with a person. In some embodiments, image analysis techniques are used to search profile pictures of the remaining social media platform profiles for the detected faces not associated with a person. In some embodiments, image analysis techniques are used to find images other than the profile pictures of the remaining social media platform profiles that comprise the detected faces not associated with a person. In some implementations, the control circuitry searches images in posts associated with the user profiles, such as images posted by or posted to the user profiles.

In some embodiments, the control circuitry searches or queries a social media platform (e.g., the social media platform discussed in relation to FIG. 2, or another social media platform) to identify profiles having a picture comprising one of the detected faces not associated with a person. In some implementations, the control circuitry searches the social media platform using detected face embeddings and queries any matches (e.g., images depicting the detected face) to determine if the match maps to a social media platform profile. In some embodiments, if no match exists, then the detected face may be excluded from operations. In some examples, detected faces are saved for subsequent searches at a later time, or for searches on other social media platforms. In some implementations, the control circuitry queries a first server that has access to a first plurality of stored images to identify profiles corresponding to tagged persons and/or to identify profiles having a picture comprising one of the detected faces not associated with a person. The control circuitry queries a second server that has access to a second plurality of stored images to identify profiles having a picture comprising one of the detected faces not associated with a person. In some examples, the first plurality of stored images are for a first social media platform and the second plurality of stored images are for a second social media platform different from the first social media platform. In some examples, the first server provides access to the first social media platform and the second server provides access to the second social media platform.

In some embodiments, the control circuitry searches the identified profiles to identify information about unidentified persons corresponding to the detected faces that are not associated with a person. In some implementations, the identified profiles comprise posts or comments that mention the unidentified persons. In some implementations, the identified profiles comprise an image having characteristics similar to the posted image (e.g., similar attire, setting, or branding on the image), and captions or comments posted for the image are used to determine information about the unidentified persons. In some embodiments, the posted image is part of a post comprising a caption or comments. In some implementations, the control circuitry determines information about unidentified persons based on the caption or comments. For example, the caption or comments may mention other persons that are not tagged in the posted image. In some implementations, characteristics of the posted image comprise the caption or comments.

In some embodiments, the control circuitry searches web content or other content to determine the identity of unidentified persons. In some embodiments, the control circuitry performs a web search using information corresponding to identified persons. For example, if the identified persons work for the same company, then the control circuitry may search a website for the company, or search the web for information relating to the company, and analyze search results to determine the identity of unidentified persons. In some embodiments, the control circuitry performs a web search using characteristics of the subject image 210. For example, if the image depicts persons at an event, then the control circuitry may search for web content related to the event (e.g., websites, posts, images, etc.) and analyze search results to determine the identity of unidentified persons. In some embodiments, the control circuitry performs an image search of the web using the image 110 (e.g., or portion thereof) to determine the identities of the unidentified persons. For example, image search results may link to a website or post that provides information on persons depicted in the image. In some implementations, the control circuitry searches any of a photo repository, photo hosting site, or photo account to identify an image depicting the unidentified person. In some examples, the control circuitry uses a profile associated with the identified image (e.g., a poster of the image) to determine the identity of unidentified person. Thus, searching web content or other content may provide additional information (e.g., websites, blog posts, publications, data stores, etc.) that is used to identify detected persons and/or determine social dynamics between detected persons (e.g., or between identified and unidentified persons).

The process 200 optionally continues to operation 284 with the control circuitry determining information for detected faces that are not associated with a person or a social media platform profile, such as discussed in relation to FIG. 1, and below in relation to FIGS. 5-7 and 9. In some embodiments, the control circuitry requests verification of information determined for the detected faces that are not associated with a person or a profile. For example, the determined information is presented in several pre-populated fields (e.g., to a user). As shown in FIG. 2, a school and start date and end date for attending the school are presented for verification. The control circuitry may receive an input confirming the data for the pre-populated fields is correct. In some embodiments, the control circuitry requests verification for all determined information or for a subset of determined information. In some embodiments, the control circuitry requests additional information (e.g., for fields not pre-populated).

In some embodiments, the control circuitry generates pseudo profiles for persons corresponding to the detected faces for which a social media platform profile was not found. The determined information for a person is stored in a corresponding pseudo profile for the person. In some implementations, any of third-party resources, data stores or brokers, or web search links are leveraged to build the pseudo profile. In some examples, the control circuitry records links and/or images accumulated while building the pseudo profile as metadata. In some implementations, a social media platform (e.g., control circuitry thereof) identifies a pseudo profile for a user attempting to create a corresponding profile for the social media platform. The social media platform presents the identified pseudo profile to the user to help the user create or modify the corresponding profile.

The process 200 continues to operation 286 with the control circuitry generating a list of identified profiles to include the list of persons tagged and profiles having a profile picture comprising one of the detected faces not associated with a person, such as described above with respect to FIG. 1. In some embodiments, the list is an abbreviated version of the list of persons tagged in the subject image 210. In some embodiments, the list comprises persons in addition to the list of persons tagged in the subject image 210. In some embodiments, the control circuitry generates for display a message or alert indicating that information could not be found for a person or that a person was excluded from at least one of the operations 268-286.

In some embodiments, the control circuitry detects a person but does not detect a face (e.g., faces that are obstructed or have visibility issues). The control circuitry determines characteristics of the subject image 210, such as discussed below in relation to FIGS. 6A-6E and 9, and compares the characteristics to other images. For example, the subject image 210 may be posted with other images or may be a frame of a video. In some implementations, the control circuitry compares any of attire of the obstructed person, faces or attire of unobstructed persons in the subject image 210, or the surroundings to identify other photos or frames comprising the obstructed person. In some examples, the other images or frames are analyzed to determine whether they comprise tags, and the tags are used to search social media platform profiles. In some examples, a face of the obstructed person is detected in one of the other images, and the detected face of the obstructed person is used to search social media platform profiles.

In some embodiments, the control circuitry searches image captions posted along with images to identify information, such as names or titles, that may provide additional information about depicted persons for which a profile is not found. For example, image captions may be searched to identify information about family, friendship, or collegial relationships.

In some implementations, the control circuitry requests verification of any one or a combination of duplicate or multiple profiles, profiles identified based on a weak match with a detected person and a corresponding profile picture, profiles identified based on a match with a detected person and an image that is not a profile picture (e.g., non-profile pictures), or any other identified profiles that require verification.

FIG. 2 is an illustrative example of a method, and other methods including fewer, additional, or alternative steps are possible consistent with this disclosure. Various modifications can be made to the process 200 in accordance with various embodiments disclosed herein. For example, in some embodiments, at least one of the operations of the process 200 may be omitted. In some embodiments, process 200 includes manual process(es), and at least one of its operations is performed by a user or operator. In some embodiments, process 200 is an automated process, and at least one of its operations is performed using the control circuitry.

FIG. 3 is a flowchart of a process 300 for determining social dynamics between persons in an image (e.g., subject image 110, 210 of FIGS. 1 and 2 or subject image 610 of FIG. 6A), in accordance with embodiments of the disclosure. In some embodiments, the process 300 is executed after the process 200 discussed in relation to FIG. 2, or based on information determined by the process 200. For example, the process may use a list of identified profiles generated by the process 200.

The process 300 begins to operation 302 with control circuitry (e.g., control circuitry 190 of FIG. 1, or control circuitry 1004, 1111 of FIGS. 10 and 11), for each field of identified profiles, generating a mapping of the identified profiles. In some embodiments, the mapping comprises a graph data structure for each field. In some implementations, the graph data structure is generated using a graph embedding method. In some embodiments, the mapping is generated for each identified profile in the Image_Profile_List discussed above in relation to FIG. 2. In some embodiments, the graph data structure comprises a graph database. In the embodiment depicted in FIG. 3, an example the mapping comprises a graph database format having vertices connected by edges. In some embodiments, the vertices include information on entities and the edges represent connections between the entities. For example, in a graph database for an education field, the vertices may include persons and schools and the edges may connect a person to schools the person attended. The edges may also include information about the connection, such as a type of degree (e.g., high school diploma, Bachelor of Science, Master of Arts, Doctor of Medicine, etc.) and/or subject of degree (e.g., Engineering, Biology, Graphic Design, Internal Medicine, etc.) a person earned from a school.

In some embodiments, the fields include any one or a combination of name, title, location, employer, education, skills, recommendations, patents, and languages. In some implementations, a field has multiple entries, such as an employer, education skills, to name a few examples. In some implementations, a field has dates, or a date range, associated with each entry, such as an employer and education skills, to name a few examples.

The process 300 continues to operation 304 with the control circuitry performing graph feature extraction to obtain features from the mappings. In some embodiments, embedding algorithms are used for the mapping. In some implementations, the embedding algorithms account for other contextual data provided for the specific field on the social profile such as Valedictorian for an undergraduate degree, in addition to the college name and years at that college. In some implementations, any of graph neural networks, graph attention networks, or graph convolution networks are used for the mapping.

In some embodiments, a trained machine learning model is used to perform the graph feature extraction. In some implementations, each field is a convolution layer in the machine learning model. In some embodiments, the mapping of the identified profiles is used to train the machine learning model.

The process 300 continues to operation 306 with the control circuitry converting graph structure for each field common between persons into a node embedding vector format. In some embodiments, the node embedding vector format comprises graph embeddings.

The process 300 continues to operation 308 with the control circuitry determining similarity values between the identified profiles, for each field, by running classification focused machine learning algorithms. In some embodiments, the machine learning algorithms comprise a graph convolutional network or graph neural network. In some embodiments, any of extreme gradient boosting, random forest, logistic regression, support vector machine, or light gradient boosting are used as a multi-level classifier machine learning algorithm. In some implementations, extreme gradient boosting is a preferred classifier. In some implementations, binary classification is performed. In some embodiments, a tabular mode may be used instead of converting data into graph form.

The process 300 continues to operation 310 with the control circuitry mapping similarity values between the identified profiles, for each field. In the embodiment depicted in FIG. 3, a table is shown depicting empty cells for storing the similarity values between persons for a single field. Although a table is shown, in some embodiments, other data structures or repositories are used. In some examples, any of arrays, linked lists, stacks, or queues are used to store the similarity values. In some embodiments, the similarity values used to indicate, for each field, a ranking or grading of the relationship between the identified profiles. In some embodiments, the similarity values range between 0 and 100. In some embodiments, the similarity values range between 0 and 1. In some embodiments, the similarity values range between-1 and 1. In some embodiments, the similarity values are a binary system (e.g., 0 or 1) that indicate whether there is a match or not between persons (e.g., either the persons went to the same university or they did not).

In some embodiments, the similarity values comprise a weighting factor, or are adjusted using a weighting factor, which adjusts initial similarity values based on the importance or relevance of the field. For example, an “education” field may not be considered relevant, and the similarity values may be adjusted accordingly using the weighting factor. In some embodiments, other numerical or non-numerical techniques are used to determine similarity values.

The process 300 continues to operation 312 with the control circuitry determining whether there are too many relationships to display, such as described above with respect to FIG. 1 (e.g., operation 158). If the determination at operation 312 is no, then the process 300 continues to operation 316.

If the determination at operation 312 is yes, then the process 300 continues to operation 314 with the control circuitry determining top fields of the identified profiles. In some embodiments, the control circuitry determines the top fields based on the context of an image (e.g., the subject image 110 of FIG. 1). In some implementations, the image was captured at a work event and fields that may be considered work-related, such as employer, title, skills, and education (e.g., school, degree, field of study, etc.) may be a top field. In some embodiments, the fields are ranked or graded to determine the top fields. In some embodiments, information from a caption for an original post and/or posts in reply to the original post are used to determine top fields. In some embodiments, the control circuitry uses a machine learning classification to determine the top fields.

The process 300 continues to operation 316 with the control circuitry determining identified profiles having similarity values exceeding a similarity threshold. In some embodiments, the control circuitry determines the similarity values only for the top fields.

The process 300 continues to operation 318 with the control circuitry, determining a relationship between the identified profiles having similarity values exceeding the similarity threshold. In some embodiments, the similarity threshold is determined based on the similarity values. In some implementations, the similarity threshold is determined based on a natural break in the distribution of similarity values. In some implementations, the similarity threshold is determined based on a percentile or percentage, such as similarity values in the top 30%, the top 15%, or the top 5%, to name a few examples. In some implementations, the similarity threshold is determined based on a quantity of similarity values or fields (e.g., a lower threshold may be used for a lower quantity).

The process 300 continues to operation 320 with the control circuitry storing the determined relationships in metadata associated with the image, such as described above with respect to FIG. 1.

The process 300 continues to operation 322 with the control circuitry generating an enriched image (e.g., enriched image 112 of FIG. 1 or enriched images 412A, 412B, 512A, 512B, 612B-E, 912A, 912B of FIGS. 4A-5, 6B-6E, and 9) that displays the determined relationships, such as described above with respect to FIG. 1 and below with respect to FIGS. 4A-5D. In some embodiments, the enriched image comprises visual identifiers with the image.

FIG. 3 is an illustrative example of a method, and other methods including fewer, additional, or alternative steps are possible consistent with this disclosure. Various modifications can be made to the process 300 in accordance with various embodiments disclosed herein. For example, in some embodiments, at least one of operations may be omitted. In some embodiments, process 300 is a manual process and at least one of its operations is performed by a user or operator. In some embodiments, process 300 is an automated process and at least one of its operations is performed using the control circuitry.

In some embodiments, the control circuitry queries a viewer of the enriched image to solicit feedback on the determined relationships or other operations of process 200 (of FIG. 2) or process 300. In some implementations, the feedback is used to train a machine learning model to determine relationships between persons.

In some embodiments, the top fields of the identified profiles are determined based on activities on a social media platform, such as a creator and/or influencer that has a higher number of posts and engagement activity. In some implementations, the control circuitry identifies the top fields based on activities of followers in terms of engagement on the platform (e.g., likes, reposts, comments, etc.). In some embodiments, the top fields are identified based on a person's presence on a social media platform that speaks to their stature, such as number of followers or persons who are experts in a niche. In some examples, a person, or corresponding profile, that frequently posts about artificial intelligence is labeled as an expert in artificial intelligence. In some embodiments, the activities of a profile on the social media platform are saved as part of metadata and/or a pseudo profile. For example, the determination that a person that is an expert in a niche may be saved to the metadata.

FIG. 4A is an illustrative representation of enriching subject image 110 with different visual identifiers 414A indicating social dynamics between persons in the image, in accordance with embodiments of the disclosure.

In particular, FIG. 4A shows an enriched image 412A. The enriched image 412A comprises an image (e.g., subject image 110, 210 of FIGS. 1 and 2 or subject image 610 of FIG. 6A) and visual identifiers 414A. The visual identifiers 414A present the relationship between different persons. In the embodiment depicted, the visual identifiers 414A are different type of identifier than the visual identifiers 114 discussed in relation to FIG. 1. The visual identifiers 414A comprise markings or bounding boxes (e.g., in a particular pattern or color) around faces of the persons and a lead line connects the bounding boxes to a text description of the relationship between the persons. On a left side of the image, a first set of two persons are bounded by one circle and a corresponding description indicates the two persons ran a marathon together, which may indicate a personal relationship. In some embodiments, any one or a combination of information on the marathon, when the two persons ran the marathon, or information on whether the two persons run, or exercise, together frequently may be presented. On a right side of the image, a second set of two persons are each circled and a corresponding description indicates the two persons dined together at this restaurant before, which may indicate a personal relationship. In some embodiments, any one or a combination of information on the restaurant, when the two persons last dined at the restaurant, or information on whether the two persons dine together frequently may be presented. In some embodiments, the visual identifiers 414A comprise image captions generated by control circuitry (e.g., control circuitry 190 of FIG. 1, which may correspond to control circuitry 1004 and/or 1111 of FIGS. 10 and 11). In some implementations, the image captions change over time based on changing relationships, such as discussed in relation to FIGS. 5, 8, and 9. In some embodiments, metadata of the image comprises information about a type of the visual identifier. In some implementations, the control circuitry uses the metadata to determine which type of visual identifier to generate for display.

In some embodiments, at least a portion of the visual identifiers 414A may be overlaid on, or are not overlaid on the subject image. In some implementations, the enriched image 112 comprises the text description displayed on a side, below, or above the image. In some embodiments, the text description is provided without the circles and lead lines. In some implementations, the text description is presented in response to interaction with the image. In some embodiments, the text description is presented on a different device than a device displaying the image.

FIG. 4B is an illustrative representation of different visual identifiers 414B indicating social dynamics between persons, in accordance with embodiments of the disclosure.

In particular, FIG. 4B shows an enriched image 412B having multi-layered social dynamics data or metadata. The enriched image 412B comprises a subject image (e.g., shown as a first person (Person1) from subject image 110 of FIG. 1) and visual identifiers 414B. The visual identifiers 414B comprise images of related persons (e.g., profile pictures) and a caption explaining the relationship between the first person and the related persons (e.g., works with the first person in marketing).

In some embodiments, an interaction with the visual identifiers 414B (e.g., with an image of a second person (Person2)) causes display of additional visual identifiers 414B. In some implementations, the additional visual identifiers 414B include images of further related persons and a caption explaining the relationship between the second person and the further related persons (e.g., took training with the second person, who works with the first person in marketing). In some embodiments, the enriched images 412A, 412B allow querying multiple levels of relationships between persons in the subject image.

FIG. 5 is an illustrative representation of dynamically modifying an image with different visual identifiers indicating changing social dynamics between persons in the image over time, in accordance with embodiments of the disclosure. In some embodiments, a system (e.g., system 100 of FIG. 1), or control circuitry (e.g., control circuitry 190 of FIG. 1, or control circuitry 1004, 1111 of FIGS. 10 and 11) dynamically modifies the image.

In particular, FIG. 5 shows enriched images 512 (e.g., first enriched image 512A and second enriched image 512B) that were generated (by e.g., control circuitry) at a first time (t1) and a second time (t2). The first enriched image 512A shows New York attorneys at a law firm, Super Law, who have received recognition for their performance in the year 2023. Six persons are recognized and the first enriched image 512A identifies each person with their image and name and honorary title below their image. A first and sixth person (e.g., Person1 and Person6) are each recognized with the honorary title of “rising star.” Second, third, fourth, and fifth persons (e.g., Person2, Person3, Person4, and Person5) are each recognized with the honorary title of “super lawyer.” The persons are shown from left to right in an initial sequential order (e.g., Person1 to Person6). In some embodiments, the first enriched image 512A is posted to a social media platform. In some embodiments, the first enriched image 512A is manually generated. In some implementations, the first enriched image 512A is a subject image. In some embodiments, the first enriched image 512A is automatically generated (e.g., by the control circuitry). In some embodiments, the honorary titles are considered context information.

The second enriched image 512B is an updated version of the first enriched image 512A for the performance in the year 2024. The honorary title for each person remains the same (e.g., rising star or super lawyer), except for the third person, who now has an honorary title of “retired partner.” In some embodiments, the updated title is determined by determining information in a profile for the third person has been updated. The control circuitry updates metadata corresponding to the profile for the first person based at least in part on the determination. The control circuitry automatically generates the second enriched image 512B based at least in part on the first enriched image 512A and information from a data store (e.g., data store 120), such as discussed in relation to FIGS. 1-3. In the embodiment depicted in FIG. 5, the control circuitry generates the second enriched image 512B based at least in part on the first enriched image 512A. For example, the control circuitry generates the second enriched image 512B by modifying the first enriched image 512A, such as by moving the third person to the leftmost position and changing their title from super lawyer to retired partner, and by moving the first and second persons over a position (e.g., ordered sequentially as Person3, Person1, Person2, Person4, Person5, and Person6). Thus, the system (or control circuitry) may re-organize an image based on changing or modified social dynamics or relationships.

In some embodiments, the control circuitry monitors the data store for updates to information associated with the first enriched image 512A. In some embodiments, the control circuitry receives metadata indicating updated information for the first enriched image 512A. In some embodiments, the updated information is determined based on information in multiple data stores. In some implementations, the control circuitry uses a first data store to determine the law firm, images, names, and honorary titles for each New York attorney that has received recognition for their performance in a particular year. The control circuitry uses a second data store to determine information that is missing from or not provided in the first data store. For example, the first data store may not include an entry for the third person for the year 2024 since they are retired, and “retired partner” is not an honorary title provided by the first data store. The control circuitry searches the second data store for information on the third person and determines that the third person was retired in the year 2024. The control circuitry generates the second enriched image 512B, to illustrate updates to the first enriched image 512A, based at least in part on the information from the first and second data stores.

In some embodiments, the control circuitry generates for display the enriched images 512A, 512B in a time lapsed presentation or manner. In some implementations, the enriched images 512A, 512B are presented as sequential images. In some embodiments, the first enriched image 512A is presented in a manner that morphs into the second enriched image 512B. Thus, the control circuitry may present social dynamics across a temporal domain. In some embodiments, the control circuitry stores the differences in the enriched images 512A, 512B in metadata for the enriched images 512A, 512B. In some implementations, the control circuitry stores a history of the changes of the enriched images 512A, 512B in metadata. In some implementations, the control circuitry uses the metadata to generate the time lapsed presentation. In some embodiments, the control circuitry updates other technical aspects of the system. In some implementations, the technical aspects include any of the lists of persons or list of identified profiles discussed in relation to FIG. 2. In some implementations, the technical aspects include the mapping of identified profiles discussed in relation to FIG. 3. In some implementations, the technical aspects include any of the determination and/or mapping of similarity values or identified profiles having similarity values exceeding a similarity threshold discussed in relation to FIG. 3.

In some embodiments, the control circuitry generates any of the enriched images 512A, 512B using the image of each person to look up the person's name or honorary title, such as described in the processes 150, 200, 300 discussed in relation to FIGS. 1, 2, and 3 and process 860 of FIG. 8. In some embodiments, the first enriched image 512A is a subject image and the control circuitry generates the second enriched image 512B based on the subject image. In some embodiments, the image for the first enriched image 512A is cropped such that at least one person is no longer identifiable or is excluded and the control circuitry generates a new enriched image based on the persons depicted in the cropped image.

FIGS. 6A-6E are illustrative representations of modifying an image with different visual identifiers indicating social dynamics between persons in the image, in accordance with embodiments of the disclosure.

FIG. 6A shows a subject image 610 (or, e.g., subject image 110, 210 of FIGS. 1, 2, and 4) depicting eleven persons 622A-K at an event. The subject image 610 comprises several characteristics. For example, the persons 622A-K are wearing formal attire, such as suits and dresses, and are present in a ballroom or conference room having neutral color carpeting and tracks in the ceiling for moving wall panels to configure the room size. In some embodiments, the event is a banquet or formal event hosted by an organization. Persons 622C-J are posing in the subject image 610. Persons 622A and 622B are to the left of the persons 622C-J and in the background. Person 622K is to the right of the persons 622C-J and in the background and is walking out of the frame. The subject image is shown with an organizational logo 626 on the bottom right corner, which indicates the organization and the purpose of the event.

In some embodiments, control circuitry (e.g., control circuitry 190 of FIG. 1, or control circuitry 1004, 1111 of FIGS. 10 and 11) analyses the subject image 610 to determine context for the subject image 610 and/or relationships between the persons 622A-K depicted in the subject image 610. In some embodiments, the control circuitry determines the subject image 610 is from an event based on the attire of the persons 622A-K depicted, the setting, and the organizational logo 626. For example, the control circuitry may identify the setting as a ballroom based on identifying the carpet type of ceiling tracks. The control circuitry may identify the organization and the purpose of the event as a 40th anniversary awards banquet for a space exploration company based on the organizational logo 626 and the attire. In some embodiments, the control circuitry may determine the persons 622C-J form different groups or cliques based on any one or a combination of attire, posture or stance, gestures, distance appearing between persons in an image, or demographics (e.g., age, gender, race, etc.), to name a few examples. In the embodiment depicted in FIG. 6A, the control circuitry determines the persons 622A and 622B form a first group 624A, the persons 622E-H form a second group 624B, and the persons 622I and 622J form a third group 624C.

In some embodiments, the control circuitry determines second group 624B based on any one or a combination of the persons 622E-H (i) being physically close (e.g., arms behind another), (ii) being close in age, (iii) wearing similar attire (e.g., long formal dresses), or (iv) having a posture that indicates a group (e.g., the positioning and posture is such that the persons 622E-H form a semi-circular shape). Person 622F is performing a gesture by reaching to the sky, which may indicate a personal relationship among the persons 622E-H. In some embodiments, the control circuitry determines first group 624A based on any one or a combination of (i) a distance appearing between the person 622E and each of the persons 622C and 622D, (ii) that persons 622C and 622D have their arms around one another, (iii) that person 622C is angled toward and leaning into person 622D, or (iv) that the persons 622C and 622D are wearing matching or complementary attire. In some embodiments, the control circuitry determines third group 624C based on any one or a combination of (i) the person 622I placing her hand on an arm of the person 622H in a non-personal manner, (ii) the rigid poses of persons 622I and 622J, which differ from the relaxed poses of the persons 622C-H, (iii) the persons 622I and 622J wearing attire stylistically different from the persons 622C-H (e.g., more conservative attire), or (iv) the persons 622I and 622J being close in age to one another and far in age from persons 622C-H. In some embodiments, the control circuitry determines the persons 622A and 622B know one another based any one or a combination of that they are (i) positioned close to one another, (ii) close in age, and (iii) wearing similar attire. In some embodiments, the control circuitry determines the persons 622A, 622B, and 622K are not part of groups 624A-C based on any one or a combination of that they (i) are in the background of the subject image 610 and (ii) have a posture facing away from the persons 622C-J. In some embodiments, the groups 624A-C are determined based on a relationship between the persons 622A-K and a viewer of the enriched image 612E.

FIGS. 6B-6E show examples of enriched images 612 (e.g., enriched images 612B-E) that are generated (e.g., by the control circuitry) with different visual identifiers (e.g., visual identifiers 630, 632A-C, 634, and 636A and 636B) based at least in part on the determined context for the subject image 610 and/or relationships between the persons 622A-K depicted in the subject image 610. The enriched image 612B of FIG. 6B is numbered to match the figure number and there is no enriched image 612A depicted in FIGS. 6A-6E. Some elements labeled in FIG. 6A are not labeled in FIGS. 6B-6E (e.g., the persons 622A-K) to avoid overcomplicating the drawing. The enriched images 612 may provide different ways to visually present the relationships between the persons 622C-J in the groups 624A-C.

In FIG. 6B, the control circuitry generates the enriched image 612B by modifying the subject image 610 with the visual identifier 630 of adding distance between the groups 624A-C. In the embodiment depicted in FIG. 6B, the persons 622C and 622D are moved a distance to the left of the person 622E to create a space between the first group 624A and the second group 624B. The distance appearing between the persons 622C and 622D remains unchanged. The persons 622I and 622J are moved a distance to the right of the person 622H to create a space between the first group 624A and the second group 624B. The distance appearing between the persons 622I and 622J remains unchanged. In some embodiments, the control circuitry determines that the persons 622I and 622J do not know one another based on any one or a combination of (i) the distance appearing between the persons 622I and 622J, (ii) the unusually “stiff” body posture of person 622J, or (iii) facial expressions of the persons 622I and 622J (e.g., that person 622I has an open-mouth smile and person 622J has a closed-lip, polite smile). In such embodiments, the distance appearing between the persons 622I and 622J is increased.

In FIG. 6C, the control circuitry generates the enriched image 612C by modifying the subject image 610 with the visual identifiers 632A-C of changing the look of the persons in the groups 624A-C. In the embodiment depicted in FIG. 6C, first visual identifiers 632A of party hats are added to the persons 622C and 622D in the first group 624A. Second visual identifiers 632B are added to change dresses of the persons 622E-H in the second group 624B to be the same dress. In some embodiments, any of a color of, or pattern on, each dress is changed to be the same or to match. Third visual identifiers 632C of patches are added to an arm of the persons 622I and 622J in the third group 624C.

In FIG. 6D, the control circuitry generates the enriched image 612D by modifying the subject image 610 with the visual identifier 634 of removing persons that are not in the second group 624B. In the embodiment depicted in FIG. 6D, the persons 622C, 622D, 622I, and 622J are removed. In some embodiments, any of more, less, or all persons that are not in the second group 624B are removed.

In FIG. 6E, the control circuitry generates the enriched image 612E by modifying the subject image 610 with the visual identifiers 636A and 636B of adding persons to the subject image 610. In the embodiment depicted in FIG. 6E, a first visual identifier 636A of a first new person is added and a second visual identifier 636B of a second new person is added. The first person is positioned behind and between the persons 622C and 622D. The second new person is positioned at the rightmost side of the enriched image 612E and to the right of person 622J. In some embodiments, the first and second new persons are added at the positions based on any one or a combination of their (i) relationships with the first group 624A and the third group 624C, (ii) association with the hosting organization, or (iii) relationship with any of the persons 622C-J. In some embodiments, the first and second new persons are added based on a relationship with a viewer of the enriched image 612E.

In some embodiments, visual identifiers comprise a modification to positions of the persons 622A-622K to indicate the social dynamics between persons in the image. For example, the control circuitry may determine that person 622D was awarded an award and based on this determination, moves the persons 622E and 622F to the left and positions the person 622D in the center of the subject image 610 between the persons 622F and 622G. In some implementations, persons are positioned based on any of seniority, position title, relationship to a viewer of the enriched image 612, to name a few examples.

FIG. 7 is a flowchart of a process for determining a relationship between an entity and a subject person in an image (subject image 110, 210, 610 of FIGS. 1, 2, 4, and 6A), in accordance with embodiments of the disclosure. In some embodiments, the process is performed to personalize determination and presentation of social dynamics to a particular entity. In some embodiments, the process 700 is performed to enhance public safety.

The process 700 begins at operation 702 with control circuitry (e.g., control circuitry 190 of FIG. 1, or control circuitry 1004, 1111 of FIGS. 10 and 11) receiving an image of the subject person (e.g., an unidentified person) at a location associated with the entity. In some embodiments, the entity is any one or a combination of a company, club, organization, or group of persons. In some embodiments, the entity is a person. In some embodiments, the entity is a viewer of the image. In some embodiments, the location is any one or a combination of a town, city, or global positioning system (GPS) coordinates, or a residence of, property owned by, workplace of, a place frequented by or previously visited by, or a place mentioned by (e.g., in an online post or verbally) the subject entity. In some embodiments, the image of the subject person depicts a landmark associated with the subject entity. In some examples, the landmark is any one or a combination of a house, office, restaurant, classroom, educational facility, or object or feature of a landscape or town. In some embodiments, the control circuitry receives the image of the subject person and determines whether the image was captured at the location associated with the subject entity or whether the image depicts the landmark associated with the subject entity. In some embodiments, the image is captured by a camera. In some implementations, the camera is remote from or located at a location at which the subject entity is present. In some implementations, the camera is a security camera. In some examples, the security camera is for a company or group and the control circuitry identifies the subject person's relationship with an employee of the company or member of the group. In some implementations, the camera is associated with the entity and/or a user account or profile of the subject entity. In some implementations, the camera is not associated with the subject entity.

The process 700 continues to operation 704 with the control circuitry determining whether a relationship exists between the subject person and the entity, such as discussed in relation to FIGS. 1-3. In some embodiments, the entity is depicted in a different image (e.g., subject image 110, 210, 610 of FIGS. 1, 2, 4, and 6A) with the subject person. In some implementations, the different image was captured at an earlier time or before the received image was captured. In some implementations, the operation 704 is based at least in part on or after a determination that image was captured at the location or landmark associated with the entity. In some embodiments, the entity is a first person, and the subject person is determined to be a second person that was detected in a single image with the first person. In some embodiments, the entity is a business or employee of the business, the subject person is an influencer, and the control circuitry determines a relationship exists in that the influencer is influential in a subject matter, service, or product that is relevant to the business (e.g., a food critic or chef at a restaurant, an outdoor enthusiast at an outdoor recreation store, or a lifestyle influencer at an entertainment venue, to name a few examples).

If the determination at operation 704 is no, then the process 700 continues to operation 706 with the control circuitry providing a notification that indicates (i) that the subject person is currently at the location and (ii) a relationship between the entity and the subject person could not be determined. In some embodiments, the notification comprises only one of (i) or (ii). In some embodiments, the subject person is denied entry to a location based at least in part on being unable to determine a relationship.

If the determination at operation 704 is yes, then the process 700 continues to operation 708 with the control circuitry providing a notification that indicates (i) that the subject person is currently at the location and (ii) the determined relationship between the entity and the subject person. In some embodiments, the notification comprises only one of (i) or (ii). In some embodiments, the subject person is granted entry to a location based at least in part on the determined relationship.

In some embodiments, the operations of process 700 account for privacy settings or considerations. For example, if the entity is any one of (i) a certain distance in connection to, or degree of separation from, subject person or (ii) has a profile (e.g., social media platform profile) that is blocked by the subject person, or if the subject person has a private profile, then the privacy considerations are preserved. In some implementations, the control circuitry is prevented from determining whether a relationship exists between the subject person and the entity. In some implementations, the certain distance in connection comprises a connection threshold. In some examples, distance in connections include a first-degree connection for direct connections, a second-degree connection for mutual connections, a third-degree connection for a connection through a second-degree connection, and no connection for the remainder. In some examples, the distance threshold is a third-degree connection such that distance in connections exceeding the distance threshold (e.g., fourth-degree connections) are considered as no connection. The connection threshold be set to any of the distance in connections.

FIG. 7 is an illustrative example of a method, and other methods including fewer, additional, or alternative steps are possible consistent with this disclosure. Various modifications can be made to the process 700 in accordance with various embodiments disclosed herein. For example, in some embodiments, at least one of operations may be omitted. In some embodiments, process 700 is a manual process and at least one of its operations is performed by a user or operator. In some embodiments, process 700 is an automated process and at least one of its operations is performed using the control circuitry.

FIG. 8 is a sequence diagram 800 defining communication between system 100 and a social profile repository 830 (or, e.g., data store 120 of FIG. 1 or database 1105 of FIG. 11), in accordance with embodiments of the disclosure.

A process 860 depicted by the sequence diagram 800 includes a series of operations. Reading from the top to the bottom of FIG. 8, in some embodiments, each operation may be performed in response to the previous operation. Operations are repeated, duplicated, and/or omitted in some embodiments. Additional operations disclosed herein are included in some embodiments. Messages between entities are depicted as horizontal arrows with the name of the message superimposed above the arrows.

The process 860 includes system 100 (or, e.g., control circuitry 190 of FIG. 1 or control circuitry 1004, 1111 of FIGS. 10 and 11) extracting 862 face embeddings from an image (e.g., subject image 110, 210, 610 of FIGS. 1, 4, or 6A), such as discussed in relation to FIGS. 1 and 2. In some embodiments, the control circuitry identifies facial features of faces depicted in the image. The process 860 continues with system 100 transmitting 864 the extracted face embeddings to the social profile repository 830, which receives the extracted face embeddings, such as discussed in relation to FIGS. 1 and 2. In some embodiments, the social profile repository 830 comprises control circuitry different from the control circuitry of the system 100. The process 860 continues with the social profile repository 830 pulling 866 social profiles, such as discussed in relation to FIGS. 1 and 2. In some embodiments, the extracted face embeddings are sent based at least in part on determining a person in the image is not tagged, such as discussed in relation to FIG. 2.

The process 860 continues with the social profile repository 830 computing 868 social dynamics between the persons corresponding to the face embeddings, such as discussed in relation to FIGS. 1-3. In some embodiments, the social profiles are pulled, and social dynamics are computed for profiles of a tagged person. In some embodiments, system 100 searches images of the social profile repository 830 (e.g., profile pictures). In some embodiments, system 100 queries the social profile repository 830 for images. In some embodiments, system 100 computes the social dynamics.

The process 860 continues with the social profile repository 830 transmitting 870 metadata to system 100, which receives the metadata, such as discussed in relation to FIGS. 1-3. In some embodiments, the metadata comprises the computed social dynamics. The process 860 continues with system 100 re-rendering 872 the image based on the metadata, such as discussed in relation to FIGS. 1 and 3-6E.

The process 860 continues with the social profile repository 830 receiving 874 an update to a profile, such as discussed in relation to FIG. 5 and below, in relation to FIG. 9. The process 860 continues with the social profile repository 830 re-computing 876 the social dynamics. The process 860 continues with the social profile repository 830 transmitting 878 updated metadata to system 100, which receives the updated metadata. The process 860 continues with system 100 re-rendering 880 the image based on the updated metadata, such as discussed in relation to FIG. 5 and below, in relation to FIG. 9.

In some embodiments, system 100 and/or the social profile repository 830 stores a history of the metadata. In some examples, system 100 and/or the social profile repository 830 stores changes between the metadata. In some embodiments, system 100 and/or the social profile repository 830 stores only the most recent metadata.

FIG. 9 is a schematic illustration of determined social dynamics for frames of a video, in accordance with embodiments of the disclosure. In some embodiments, the social dynamics are determined in real time (e.g., as the video is played or streamed). In some embodiments, the social dynamics can be determined offline and stored as metadata.

FIG. 9 shows enriched images 912 (e.g., a first enriched image 912A and a second enriched image 912B), which comprise images (e.g., first image and second image) from a news report of a trial and visual identifiers 914 (e.g., first visual identifiers 914A and second visual identifiers 914B). In some embodiments, the first and second images are part of the news report video. In some embodiments, the news report is any of broadcasted, played, or streamed.

The first enriched image 912A comprises a first image displayed at a first time (t1) showing three people inside a courtroom, a “happening now” tag/identifier with a relevant news section 920, a “breaking news” tag/identifier with a scrolling list of news headlines, a news station logo, and information on current weather (e.g., time and temperature). The relevant news section 920 displays predetermined information about a story (e.g., a news report) associated with what is depicted in the image. In the embodiment depicted in FIG. 9, the relevant news section 920 includes text indicating a verdict is due soon in a trial proceeding.

The first visual identifiers 914A present a relationship between persons depicted in the first image. In some embodiments, the relationships are determined (e.g., by control circuitry 190 of FIG. 1, or control circuitry 1004, 1111 of FIGS. 10 and 11) based at least in part on what is depicted in the image. For example, any one or a combination of the attire of persons depicted, objects depicted, the relevant news section 920, or the news station logo may be used to determine the relationships, such as discussed in relation to FIGS. 1 and 6A-6E. In the embodiment depicted in FIG. 9, the first visual identifiers 914A include a name and context information for each person. The first visual identifiers 914A include a marking or circle around one of the three persons, and the context information presents the relationship between each person and the circled person. In the depicted embodiment, the relevant news section 920 is used to determine the relationships. The relevant news section 920 indicates the story is about the trial and that a verdict is due. In some embodiments, information on the trial is looked up through any one or a combination of Internet sites, social media platform posts, a data store or database (e.g., data store 120 or social profile repository 830 of FIGS. 1 and 8 or database 1105 of FIG. 11), or data management system (e.g., a court record system). In some embodiments, the news station logo and/or information on current weather are used to determine information on the trial, such as when results based on the relevant news section 920 are inadequate (e.g., too few, too many, or from an unreliable source). In some embodiments, the news station logo and/or information on current weather are used to focus search using the relevant news section 920 to a particular trial location.

Returning to the embodiment depicted in FIG. 9, the context information for the circled, first person indicates she is a defendant. The context information for a second person indicates they are an attorney for the defendant. The context information for a third person indicates they are a bailiff for the defendant. The first visual identifiers 914A are displayed near or proximate to a corresponding person. In some embodiments, the first visual identifiers 914A are displayed over the corresponding persons, or attached to the corresponding person with a lead line. In some embodiments, the first person is denoted as a person of interest by an interaction received (e.g., via display 104 of FIG. 1 or display 1012 or user input interface 1010 of FIG. 10) with a portion of the image depicted the first person.

In some embodiments, the first visual identifiers 914A are updated as persons enter and/or exit the frame. In some embodiments, the first visual identifiers 914A are used to dynamically provide relationship information for any one or a combination of a video stream, real-time streaming video, or live stream as the environment and persons depicted change as the video plays or streams. In some embodiments, metadata associated with a live stream may be based at least in part on commentary (e.g., comments provided in a chat function or on social media) associated with the live stream. In the embodiment depicted in FIG. 9, the second enriched image 912B comprises a second image displayed at a second time (t2) showing two well-dressed persons standing back-to-back in an office and the same sections as the first enriched image 912A (e.g., the relevant news section 920). The second image is of a different environment or setting than the first image and is provided as part of the same news story as the first image. The second visual identifiers 914B include a name and context information for each person depicted in the second image.

In some embodiments, the control circuity uses information determined when generating the first enriched image 912A for the second visual identifiers 914B. For example, the control circuitry determines one of the two persons in the second image is Carolina, such as described in relation to FIGS. 1, 2, 5, and 8. The visual identifier 914B for Carolina includes the previously determined context information that she is the defendant along with newly determined context information that she is a former Chief Executive Officer (CEO) of Acme. In some embodiments, the control circuitry determines the newly determined context information by analyzing the second image, such as described in relation to FIGS. 1 and 6A-6E. In some embodiments, the control circuitry identifies the other of the two persons as Doug and determines that the context information includes that Doug is Chief Financial Officer (CFO) for Acme and a witness in the trial. In some implementations, the identification and/or determination is based on any one or a combination of (i) detected faces in the second image, (ii) information associated with a stored image of Carolina and/or Doug, (iii) information in a data store, (iv) information presented in the relevant news section 920, (v) information on the trial, or (vi) previously determined context information.

In some embodiments, the system stores an identity and/or social dynamics for a person that is no longer present in a frame. For example, the system may track the person back and forth in the video, or entering and exiting frames of the video, by storing a running aggregate of information associated with the first and second visual identifiers 914A, 914B (e.g., names and context information), such as in the metadata for the video or video frames. In some implementations, the control circuitry updates the information associated with the first and second visual identifiers 914A, 914B to account for relationships between persons present in the frame and persons that are not present in the frame. In some examples, the system continues to determine social dynamics between the person that is no longer present and persons that are present.

In some embodiments, the first and second images are frames of a media asset that is broadcasted, streamed, or played. In some implementations, the frames are updated over time (e.g., different frames of the media asset are presented and/or a video comprising the frames is presented). In some implementations, text displayed in the news section 920 is updated over time. In some implementations, the text displayed in the news section 920 is updated during the same news report (e.g., the text is different at the first time and the second time). In some implementations, at least one of the first and second images are a compressed frame (e.g., P-frame or B-frame) of the media asset. In some examples, the control circuitry decodes the compressed frame to analyze the corresponding image and/or generate the corresponding first or second enriched image 912A, 912B. In some implementations, at least one of the first and second images is a key frame (e.g., I-frame) of the media asset.

In some embodiments, the visual identifiers 914 are updated as the relevant news section 920 changes. In some embodiments, the visual identifiers 914 are generated (e.g., by control circuitry) in real time. In some embodiments, the visual identifiers 914 are generated without any previous knowledge of the image and its depictions.

In some embodiments, the concepts discussed in relation to FIGS. 8 and 9 are used to identify persons or faces in a frame, and track the identified faces in a list of faces that appear in the totality of frames present in a video. For example, if a Republican or Democratic National Conference is being streamed, then a relationship between persons appearing during the conference can be displayed. If the control circuitry determines a new face appears during a livestream of the conference, then the control circuitry computes relationships between the new person and others that were already mapped. In some implementations, the relationships are embedded within metadata of the video.

FIG. 10 depicts example devices and related hardware for determining and depicting up-to-date social dynamics between persons in an image, in accordance with embodiments of the disclosure. In particular, FIG. 10 shows generalized embodiments of illustrative user devices 1000 and 1001, which may correspond to computing device 102 of FIG. 1, or any other suitable devices, or any combination thereof. For example, user equipment device 1000 may be smart glasses, a virtual reality device, an XR device (e.g., computing device 102 FIG. 1), a projector or hologram projector, a smartphone device, a tablet, a smart mirror, or any other suitable device capable of displaying an image, an overlay on an image, or an overlay on real-world objects or a real-world environment and is also capable of transmitting and receiving data over a communication network. In another example, user equipment device 1001 may be a user TV equipment system, smart TV, a smartphone device, a tablet, computer monitor, projector, hologram projector, or suitable device capable of streaming a media asset. User equipment device 1001 (e.g., a TV) may include set-top box 1015. Set-top box 1015 may be communicatively connected to microphone 1016, audio output equipment (e.g., audio output equipment 1014, speaker, or headphones), display 1012 (e.g., display 104 of FIG. 1), and sensor 1013 (e.g., sensors 106 of FIG. 1). In some embodiments, set-top box 1015 receives an image (e.g., subject image 110, 210, 610 of FIGS. 1, 2, 4, and 6A) or video (e.g., the news stream discussed in relation FIG. 9) and/or may cause display of the image or video. In some embodiments, microphone 1016 may receive audio corresponding to a voice of a user, e.g., a voice command. In some embodiments, display 1012 may be a TV display or a computer display. In some embodiments, set-top box 1015 may be communicatively connected to user input interface 1010. In some embodiments, user input interface 1010 may be a remote control device. Set-top box 1015 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 10. In some embodiments, device 1000 may comprise any suitable number of sensors, as well as a GPS module (e.g., in communication with one or more servers and/or cell towers and/or satellites) to ascertain a location of device 1000.

Each one of user equipment device 1000 and user equipment device 1001 may receive content and data via input/output (I/O) path 1002. I/O path 1002 may provide content (e.g., broadcast programming, on-demand programming, Internet content, content available over a local area network (LAN) or wide area network (WAN), and/or other content) and data to control circuitry 1004 (or, e.g., control circuitry 190 of FIG. 1, or control circuitry 1111 of FIG. 11), which may comprise processing circuitry 1006 and storage 1008. Control circuitry 1004 may be used to send and receive commands, requests, and other suitable data using I/O path 1002, which may comprise I/O circuitry. I/O path 1002 may connect control circuitry 1004 (and specifically processing circuitry 1006) to one or more communications paths (described below). I/O functions may be provided by one or more of these communications paths, but are shown as a single path in FIG. 10 to avoid overcomplicating the drawing. While set-top box 1015 is shown in FIG. 10 for illustration, any suitable computing device having processing circuitry, control circuitry, and storage may be used in accordance with the present disclosure. For example, set-top box 1015 may be replaced by, or complemented by, a personal computer (e.g., a notebook, a laptop, a desktop), a smartphone, a tablet, a user-worn device (e.g., XR device), a network-based server hosting a user-accessible client device, a non-user-owned device, any other suitable device, or any combination thereof.

Control circuitry 1004 may be based on any suitable control circuitry such as processing circuitry 1006. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1004 executes instructions for system (e.g., system 100 of FIG. 1) stored in memory (e.g., storage 1008). Specifically, control circuitry 1004 may be instructed by system to perform the functions discussed above and below. In some implementations, processing or actions performed by control circuitry 1004 may be based on instructions received from system.

In client/server-based embodiments, control circuitry 1004 may include communications circuitry suitable for communicating with a server or other networks or servers. System may be a stand-alone application implemented on a device or a server. The system may be implemented as software or a set of executable instructions. The instructions for performing any of the embodiments discussed herein of the system may be encoded on non-transitory computer-readable media (e.g., a hard drive, random-access memory on a DRAM integrated circuit, read-only memory on a BLU-RAY disk, etc.). For example, in FIG. 10, the instructions may be stored in storage 1008, and executed by control circuitry 1004 of a device 1000.

In some embodiments, the system may be a client/server application where only the client application resides on device 1000, and a server application resides on an external server (e.g., server 1104). For example, the system may be implemented partially as a client application on control circuitry 1004 of device 1000 and partially on server 1104 as a server application running on control circuitry 1111. Server 1104 may be a part of a local area network with one or more of devices 1000 or may be part of a cloud computing environment accessed via the internet. In a cloud computing environment, various types of computing services for performing searches on the internet or informational data stores or databases, providing storage (e.g., for a data store or database) or parsing data are provided by a collection of network-accessible computing and storage resources (e.g., server 1104), referred to as “the cloud.” Device 1000 may be a cloud client that relies on the cloud computing capabilities from server 1104 to determine whether processing should be offloaded and facilitate such offloading. When executed by control circuitry 1004 or 1111, the system may instruct control circuitry 1004 or 1111 to perform processing tasks for the client device and facilitate a media consumption session integrated with social network services. The client application may instruct control circuitry 1004 to determine whether processing should be offloaded.

Control circuitry 1004 may include communications circuitry suitable for communicating with a server, social network service, a table or data store server, or other networks or servers The instructions for carrying out the above-mentioned functionality may be stored on a server (which is described in more detail in connection with FIG. 9). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 10). In addition, communications circuitry may include circuitry that enables peer-to-peer communication of user equipment devices, or communication of user equipment devices in locations remote from each other (described in more detail below).

Memory may be an electronic storage device provided as storage 1008 that is part of control circuitry 1004. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1008 may be used to store distinct types of content described herein as well as system data described above. Nonvolatile memory may also be used (e.g., to launch a boot-up routine and other instructions). Cloud-based storage may be used to supplement storage 1008 or instead of storage 1008.

Control circuitry 1004 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1004 may also include scaler circuitry for upconverting and down converting content into the preferred output format of user equipment device 1000. Control circuitry 1004 may also include digital-to-analog converter circuitry and analog-to-digital converter circuitry for converting between digital and analog signals. The tuning and encoding circuitry may be used by user equipment device 1000, 1001 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1008 is provided as a separate device from user equipment device 1000, the tuning and encoding circuitry (including multiple tuners) may be associated with storage 1008.

Control circuitry 1004 may receive instruction from a user by way of user input interface 1010. User input interface 1010 may be any suitable user interface, such as a remote control, mouse, trackball, keypad, keyboard, touch screen, touchpad, stylus input, joystick, voice recognition interface, eye tracking interface, or other user input interfaces. Display 1012 may be provided as a stand-alone device or integrated with other elements of each one of user equipment device 1000 and user equipment device 1001. For example, the display 1012 of the user equipment device 1000 may be a display screen or combiner and the user input interface 1010 may include an eye tracking interface that tracks the user's eye movements in relation to the display 1012. The display 1012 of the user equipment device 1001 may be a touchscreen or touch-sensitive display. In such circumstances, user input interface 1010 may be integrated with or combined with display 1012. In some embodiments, user input interface 1010 includes a remote-control device having one or more microphones, buttons, keypads, any other components configured to receive user input or combinations thereof. For example, user input interface 1010 may include a handheld remote-control device having an alphanumeric keypad and option buttons. In a further example, user input interface 1010 may include a handheld remote-control device having a microphone and control circuitry configured to receive and identify voice commands and transmit information to set-top box 1015.

Control circuitry 1004 may receive information from the sensor 1013 (or sensors). The information may include spatial data about a real-world environment and objects within, including people. Sensor 1013 may be any suitable sensor or sensors to detect a position and orientation of the surroundings. The sensor 1013 may include transceivers, cameras, sonar, radar, lidar, lasers, global positioning system (GPS) beacons, inertial measurement systems (IMSs), accelerometers, and gyrometers. The sensor 1013 may include emitters or projectors and receivers to detect reflections of an emitted source (e.g., electromagnetic waves and soundwaves), and the control circuitry 1004 may use a delay between transmitting and receiving to determine positions and orientations of the surroundings. The sensor 1013 may perform several measurements in multiple directions. In some embodiments, the control circuitry 1004 may use the sensor 1013 to scan the surroundings and capture images of one or more objects, which may be used to determine object locations within the environment. In some embodiments, the control circuitry 1004 may generate a 3D map of the surroundings, specifying locations of objects and/or locations of users in the surroundings. In some embodiments, the sensor 1013 may sense changes in its position over time, which the control circuitry 1004 may use to track the position and orientation of an object coupled to the sensor 1013. In some embodiments, a user may be requested by the control circuitry 1004 to scan his or her surroundings.

Audio output equipment 1014 may be integrated with or combined with display 1012. Display 1012 may be one or more of a monitor, a TV, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser TV, carbon nanotubes, quantum dot display, interferometric modulator display, or any other suitable equipment for displaying visual images. A video card or graphics card may generate the output to the display 1012. Audio output equipment 1014 may be provided as integrated with other elements of each one of devices 1000, 1001 or may be stand-alone units. An audio component of videos and other content displayed on display 1012 may be played through speakers (or headphones) of audio output equipment 1014. In some embodiments, audio may be distributed to a receiver (not shown), which processes and outputs the audio via speakers of audio output equipment 1014. In some embodiments, for example, control circuitry 1004 is configured to provide audio cues to a user, or other audio feedback to a user, using speakers of audio output equipment 1014. There may be a separate microphone 1016 or audio output equipment 1014 may include a microphone configured to receive audio input such as voice commands or speech. For example, a user may speak letters or words that are received by the microphone and converted to text by control circuitry 1004. In a further example, a user may voice commands that are received by a microphone and recognized by control circuitry 1004. Camera 1018 may be any suitable video camera integrated with the equipment or externally connected. Camera 1018 may be a digital camera comprising a charge-coupled device (CCD) and/or a complementary metal-oxide semiconductor (CMOS) image sensor. Camera 1018 may be an analog camera that converts to digital images via a video card. Light 1020 may be used to illuminate objects near the devices 1000 and 1001, and may include light emitting diode (LED) lights or other types of light producing devices. The light 1020 may be used with the camera 1018. Camera 1022 may be an IR or ultraviolet (UV) camera. Light 1024 may be an IR or UV emitter that emits light in the IR or UV wavelengths to reflect off nearby objects. The camera 1022 detects the reflected wavelengths.

The system (e.g., system 100) may be implemented using any suitable architecture. For example, it may be a stand-alone application wholly implemented on each one of user equipment device 1000 and user equipment device 1001. In such an approach, instructions of the application may be stored locally (e.g., in storage 1008), and data for use by the application is downloaded on a periodic basis (e.g., from an out-of-band feed, from an Internet resource, or using another suitable approach). Control circuitry 1004 may retrieve instructions of the application from storage 1008 and process the instructions to provide media consumption and social network interaction functionality and generate any of the displays discussed herein. Based on the processed instructions, control circuitry 1004 may determine what action to perform when input is received from user input interface 1010. For example, movement of a cursor on a display up/down may be indicated by the processed instructions when user input interface 1010 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1004 may allow a user to provide user profile information or may automatically compile user profile information. For example, control circuitry 1004 may access and monitor network data, video data, audio data, processing data, participation data from a system and social network profile. Control circuitry 1004 may obtain all or part of other user profiles that are related to a particular user (e.g., via social media networks), and/or obtain information about the user from other sources that control circuitry 1004 may access. As a result, a user can be provided with a unified experience across the user's different devices.

In some embodiments, the system is a client/server-based application. Data for use by a thick or thin client implemented on each one of user equipment device 1000 and user equipment device 1001 may be retrieved on-demand by issuing requests to a server remote to each one of user equipment device 1000 and user equipment device 1001. For example, the remote server may store the instructions for the application in a storage device. The remote server may process the stored instructions using circuitry (e.g., control circuitry 1004) and generate the displays discussed above and below. The client device may receive the displays generated by the remote server and may display the content of the displays locally on device 1000. This way, the processing of the instructions is performed remotely by the server while the resulting displays (e.g., that may include text, a keyboard, or other visuals) are provided locally on device 1000. Device 1000 may receive inputs from the user via user input interface 1010 and transmit those inputs to the remote server for processing and generating the corresponding displays. For example, device 1000 may transmit a communication to the remote server indicating that an up/down button was selected via user input interface 1010. The remote server may process instructions in accordance with that input and generate a display of the application corresponding to the input (e.g., a display that moves a cursor up/down). The generated display may then be transmitted to device 1000 for presentation to the user.

In some embodiments, the I/O path 1002 may generate the output to the display 1012. In some embodiments, the I/O path 1002 may include the video generating circuitry. In some embodiments, the I/O path 1002 and the control circuitry 1004 may both generate the output to the display 1012.

In some embodiments, the system may be downloaded and interpreted or otherwise run by an interpreter or virtual machine (run by control circuitry 1004). In some embodiments, the system may be encoded in the ETV Binary Interchange Format (EBIF), received by control circuitry 1004 as part of a suitable feed, and interpreted by a user agent running on control circuitry 1004. For example, the system may be an EBIF application. In some embodiments, the system may be defined by a series of JAVA-based files that are received and run by a local virtual machine or other suitable middleware executed by control circuitry 1004. In some of such embodiments (e.g., those employing MPEG-2 or other digital media encoding schemes), the system may be, for example, encoded and transmitted in an MPEG-2 object carousel with the MPEG audio and video packets of a program.

FIG. 11 depicts example systems, servers, and related hardware for enabling a metadata enrichment application to carry out the functions described herein, in accordance with some embodiments of this disclosure/shows illustrative systems, in accordance with embodiments of the disclosure.

User equipment devices 1107, 1108, 1109, 1110 (e.g., computing device 102 of FIG. 1) and/or other connected devices (e.g., sensors 106 of FIG. 1) or suitable devices, or any combination thereof, may be coupled to communication network 1106. In the depicted embodiment, the user equipment device 1107 is a personal computer, user equipment device 1108 is an XR headset, user equipment device 1109 is a smartphone, and user equipment device 1110 is a TV. Communication network 1106 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 1106) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 11 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth®, infrared, IEEE 702-11x, etc.), or other short-range communication via wired or wireless paths. The user equipment devices may also communicate with each other directly through an indirect path via communication network 1106.

System 1100 may comprise media content source 1102 (or, e.g., data store 120 of FIG. 1 or social profile repository 830 of FIG. 8), one or more servers 1104, and one or more social network services. In some embodiments, the system may be executed at one or more of control circuitry 1111 (or, e.g., control circuitry 190, 1004 of FIGS. 1 and 10) of server 1104 (and/or control circuitry of user equipment devices 1107, 1108, 1109, 1110). In some embodiments, spatial data about a real-world environment (e.g., an environment surrounding an XR device) or objects in the a real-world environment, user name and preferences, information about the media content source 1102 (e.g., present time point and time remaining), media content enhancements (e.g., visual identifiers 114, 414A, 414B, 632A, 632B, 632C, 636A, 636B, 914A, and 914B of FIGS. 1, 4, 6C, 6E, and 9), or any other suitable data structure or any combination thereof, may be stored at database 1105 (or, e.g., data store 120 or social profile repository 830 of FIGS. 1 and 8) maintained at or otherwise associated with server 1104, and/or at storage of one or more of user equipment devices 1107, 1108, 1109, 1110.

In some embodiments, server 1104 may include control circuitry 1111 and storage 1114 (e.g., RAM, ROM, Hard Disk, Removable Disk, etc.). Storage 1114 may store one or more databases 1105. Server 1104 may also include an input/output path 1112. I/O path 1112 may provide media consumption data, social networking data, device information, or other data, over a local area network (LAN) or wide area network (WAN), and/or other content and data to control circuitry 1111, which may include processing circuitry, and storage 1114. Control circuitry 1111 may be used to send and receive commands, requests, and other suitable data using I/O path 1112. I/O path 1112 may connect control circuitry 1111 (and specifically control circuitry 1004) to one or more communications paths. I/O path 1112 may comprise I/O circuitry.

Control circuitry 1111 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1111 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1111 executes instructions for an emulation system application stored in memory (e.g., the storage 1114). Memory may be an electronic storage device provided as storage 1114 that is part of control circuitry 1111.

The embodiments discussed above are intended to be illustrative and not limiting. One skilled in the art would appreciate that individual aspects of the apparatus and methods discussed herein may be omitted, modified, combined, and/or rearranged without departing from the scope of the disclosure. Only the claims that follow are meant to set bounds as to what the present disclosure includes.

1. A method, comprising:
analyzing a subject image to detect a first person and a second person depicted in the subject image;
identifying at least one of the first person or the second person in at least one stored image of a plurality of stored images, wherein the plurality of stored images is associated with a plurality of persons;
determining a relationship between the first person and the second person in the subject image based at least in part on information corresponding to the at least one stored image;
associating an indication of the determined relationship with metadata of the subject image; and
generating, for simultaneous display with the subject image, a visual identifier that indicates the determined relationship between the first person and second person.

2. The method of claim 1, wherein:
the plurality of stored images comprises a profile picture for each of a plurality of profiles of a social media platform;
at least one of the first person or the second person of the subject image is identified in at least one profile picture; and
the information corresponding to the at least one stored image comprises information from a profile of the plurality of profiles that corresponds to the at least one profile picture.

3. The method of claim 2, wherein:
the profile of the plurality of profiles that corresponds to the at least one profile picture is a first profile;
the plurality of stored images comprises non-profile pictures for at least a portion of the plurality of profiles of the social media platform;
the identifying at least one of the first person or the second person comprises (i) identifying the first person in the at least one profile picture and (ii) determining that the profile pictures of the social media platform do not comprise the second person;
the method further comprises, based at least in part on the determining that the profile pictures of the social media platform do not comprise the second person, identifying the second person in at least one stored image of the non-profile pictures; and
wherein the determining the relationship between the first person and the second person in the subject image is further based on information from a second profile of the plurality of profiles that corresponds to the at least one stored image of the non-profile pictures.

4.-6. (canceled)

7. The method of claim 1, wherein:
the identifying at least one of the first person or the second person comprises identifying the first person and not the second person in the at least one stored image of the plurality of stored images;
the information corresponding to the at least one stored image is information associated with the first person;
the method further comprises determining information about the second person based at least in part on at least one of (i) characteristics of the subject image or (ii) the information associated with the first person; and
wherein the determining the relationship between the first person and the second person in the subject image is further based on the determined information about the second person.

8.-9. (canceled)

10. The method of claim 1, wherein:
the plurality of stored images are a first plurality of stored images;
the method further comprises:
determining the second person is not in the first plurality of stored images; and
based at least in part on determining the second person is not in the first plurality of stored images, identifying the second person in at least one stored image of a second plurality of stored images; and
wherein the determining the relationship between the first person and the second person is further based on information corresponding to the at least one stored image of the second plurality of stored images.

11.-12. (canceled)

13. The method of claim 1, wherein the relationship between the first person and the second person in the subject image is a first relationship determined at a first time, the method further comprising:
determining a second relationship between the first person and the second person based at least in part on information corresponding to the at least one stored image at a second time later than the first time, wherein the information from the second time is different from the information from the first time; and
updating the metadata of the subject image with an indication of the determined second relationship.

14.-18. (canceled)

19. The method of claim 1, wherein the generating, for simultaneous display with the subject image, the visual identifier comprises modifying, based at least in part on the determined relationship between the first person and second person, the subject image to adjust a location of the first person in relation to the second person within the subject image.

20. The method of claim 1, wherein the generating, for simultaneous display with the subject image, the visual identifier comprises modifying, based at least in part on the determined relationship between the first person and second person, an appearance of at least one of the first or second person depicted in the subject image.

21. The method of claim 1, wherein associating an indication of the determined relationship with metadata of the subject image comprises modifying the metadata to include any one or more of (i) an indication of one or more portions of the subject image that comprise at least one of the depiction of the first or second person, (ii) an identity of at least one of the first person or the second person, (iii) the information corresponding to the at least one stored image, or (iv) information about a type of the visual identifier.

22. The method of claim 1, further comprising:
receiving, from a user device, a request for relationship information between two persons depicted in a particular image;
determining the particular image is the subject image, and the two persons are the first and second person; and
providing, to the user device, the metadata without the subject image.

23.-25. (canceled)

26. A system, comprising:
control circuitry configured to:
analyze a subject image to detect a first person and a second person depicted in the subject image;
identify at least one of the first person or the second person in at least one stored image of a plurality of stored images, wherein the plurality of stored images is associated with a plurality of persons;
determine a relationship between the first person and the second person in the subject image based at least in part on information corresponding to the at least one stored image;
associate an indication of the determined relationship with metadata of the subject image; and
generate, for simultaneous display with the subject image, a visual identifier that indicates the determined relationship between the first person and second person.

27. The system of claim 26, wherein:
the plurality of stored images comprises a profile picture for each of a plurality of profiles of a social media platform;
at least one of the first person or the second person of the subject image is identified in at least one profile picture; and
the information corresponding to the at least one stored image comprises information from a profile of the plurality of profiles that corresponds to the at least one profile picture.

28. The system of claim 27, wherein:
the profile of the plurality of profiles that corresponds to the at least one profile picture is a first profile;
the plurality of stored images comprises non-profile pictures for at least a portion of the plurality of profiles of the social media platform;
the control circuitry is further configured to:
identify at least one of the first person or the second person by (i) identifying the first person in the at least one profile picture and (ii) determining that the profile pictures of the social media platform do not comprise the second person; and
based at least in part on the determining that the profile pictures of the social media platform do not comprise the second person, identify the second person in at least one stored image of the non-profile pictures; and
wherein the determining the relationship between the first person and the second person in the subject image is further based on information from a second profile of the plurality of profiles that corresponds to the at least one stored image of the non-profile pictures.

29.-31. (canceled)

32. The system of claim 26, wherein:
the control circuitry is further configured to identify at least one of the first person or the second person by identifying the first person and not the second person in the at least one stored image of the plurality of stored images;
wherein the information corresponding to the at least one stored image is information associated with the first person;
the control circuitry is further configured to determine information about the second person based at least in part on at least one of (i) characteristics of the subject image or (ii) the information associated with the first person; and
wherein the determining the relationship between the first person and the second person in the subject image is further based on the determined information about the second person.

33.-34. (canceled)

35. The system of claim 26, wherein:
the plurality of stored images are a first plurality of stored images;
the control circuitry is further configured to:
determine the second person is not in the first plurality of stored images; and
based at least in part on determining the second person is not in the first plurality of stored images, identify the second person in at least one stored image of a second plurality of stored images; and
wherein the determining the relationship between the first person and the second person is further based on information corresponding to the at least one stored image of the second plurality of stored images.

36.-37. (canceled)

38. The system of claim 26, wherein:
the relationship between the first person and the second person in the subject image is a first relationship determined at a first time; and
the control circuitry is further configured to:
determine a second relationship between the first person and the second person based at least in part on information corresponding to the at least one stored image at a second time later than the first time, wherein the information from the second time is different from the information from the first time; and
update the metadata of the subject image with an indication of the determined second relationship.

39.-43. (canceled)

44. The system of claim 26, wherein the control circuitry is further configured to generate, for simultaneous display with the subject image, the visual identifier by modifying, based at least in part on the determined relationship between the first person and second person, the subject image to adjust a location of the first person in relation to the second person within the subject image.

45. The system of claim 26, wherein the control circuitry is further configured to generate, for simultaneous display with the subject image, the visual identifier by modifying, based at least in part on the determined relationship between the first person and second person, an appearance of at least one of the first or second person depicted in the subject image.

46. The system of claim 26, wherein the control circuitry is further configured to associate an indication of the determined relationship with metadata of the subject image by modifying the metadata to include any one or more of (i) an indication of one or more portions of the subject image that comprise at least one of the depiction of the first or second person, (ii) an identity of at least one of the first person or the second person, (iii) the information corresponding to the at least one stored image, or (iv) information about a type of the visual identifier.

47. The system of claim 26, wherein:
the system further comprises input/output circuitry configured to receive, from a user device, a request for relationship information between two persons depicted in a particular image; and
the control circuitry is further configured to:
determine the particular image is the subject image, and the two persons are the first and second person; and
provide, to the user device, the metadata without the subject image.

48.-125. (canceled)
